(19) United States
(12) Patent Application Publication
(10) Pub. No.: US 2026/0133697 A1
(43) Pub. Date: May 14, 2026

(54) DYNAMIC, ADAPTIVE OVER-PROVISIONING

(71) Applicant: Dropbox, Inc., San Francisco, CA (US)

(72) Inventors: Robert Woolweaver, Austin, TX (US); Eric Shobe, Kihei, HI (US)

(73) Assignee: Dropbox, Inc., San Francisco, CA (US)

(21) Appl. No.: 18/946,046

(22) Filed: Nov. 13, 2024

(51) Int. Cl. G06F 3/06; G06F 12/02

(52) U.S. Cl. CPC G06F 3/0616; G06F 3/0659; G06F 3/0679; G06F 12/0246; G06F 2212/7202

(57) ABSTRACT

The present technology improves the operation and endurance of storage drives by adapting the amount of over-provisioning for a drive to the write profile for the particular service assigned to the drive. The amount of over-provisioning for the drive is determined based on the write profile of the service and the attributes of the drive, such as the drive's specifications and the workload history of the drive. The write profile of the service can be predicted using a model that is empirical or is based on historical data. For example, the write profile can be predicted based on the similarity of the service to services in the historical data. The actual write profile of the service can be monitored, and if it deviates from the predicted write profile the amount of over-provisioning can be dynamically adjusted based on the actual write profile.

### BACKGROUND

Large-scale online services store ever-increasing amounts of data. As just one example, a large-scale centrally hosted network file system might store multiple exabytes of data on hard disks housed in data centers around the world.

Cloud storage is a model of computer data storage in which data is stored remotely in logical pools and is accessible to users over a network. The physical storage spans multiple servers and sometimes in multiple locations. The physical environment can be owned and managed by a cloud computing provider. The cloud storage provider is responsible for keeping the data available and accessible, and the physical environment secured, protected, and running.

Cloud-storage data centers can use Non-Volatile Memory Express (NVMe) solid-state drives (SSDs), which are known to have high performance and reliability. However, these drives can suffer from write amplification, which can reduce their lifespan or variable write usage of the workload on the drive.

NVMe SSDs use a peripheral component interconnect express (PCIe) interface, which can provide a higher bandwidth than Serial ATA (SATA) SSDs, in faster data transfer rates. Additionally, NVMe SSDs are designed to minimize latency in data access, resulting in faster response times when reading and writing data, which makes them well suited for applications requiring quick data retrieval. Also, NVMe supports multiple queues and commands, allowing the SSD to handle a higher number of simultaneous requests, which can be beneficial in multi-threaded environments, where tasks can be executed in parallel. Many NVMe SSDs incorporate features like power loss protection, thermal throttling, and self-healing technologies, further improving reliability in demanding environments.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 illustrates an example of a content management system and client devices, in accordance with some embodiments of the present technology.

FIG. 2A illustrates a block diagram of a data center that includes a data storage system, in accordance with some embodiments of the present technology.

FIG. 2B illustrates a block diagram of an example data storage drive, in accordance with some embodiments of the present technology.

FIG. 2C illustrates pages in a block of a solid-state drive, in accordance with some embodiments of the present technology.

FIG. 2D illustrates an example of a model of a service, in accordance with some embodiments of the present technology.

FIG. 2E illustrates an example of a model of a storage drive, in accordance with some embodiments of the present technology.

FIG. 2F illustrates an example of an aging model of a storage drive, in accordance with some embodiments of the present technology.

FIG. 3 illustrates an example of garbage collection on a solid-state drive, in accordance with some embodiments of the present technology.

FIG. 4 illustrates a flow diagram of a method for determining an amount of over-provisioning on a storage drive based on information of the service for which the drive is to be used, in accordance with some embodiments of the present technology.

FIG. 5 illustrates a set of data centers, in accordance with some embodiments of the present technology.

FIG. 6 illustrates the logical structure of the data storage system, in accordance with some embodiments of the present technology.

FIG. 7 illustrates the structure of an object storage device, in accordance with some embodiments of the present technology.

FIG. 8 illustrates an example of a solid-state drive architecture, in accordance with some embodiments of the present technology.

FIG. 9 illustrates a flow diagram of a method of training, using, and updating a machine learning (ML) model, in accordance with some embodiments of the present technology.

FIG. 10 illustrates a block diagram for an example of a computing device, in accordance with some embodiments of the present technology.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

As discussed above, NVMe SSDs are highly desired due to their high performance and reliability. However, these drives can suffer from write amplification, which can reduce their lifespan. Over-provisioning can partially mitigate write amplification and improve the drive's endurance and performance. Over-provisioning refers to reserving a portion of the drive's capacity for internal use. The optimal amount of over-provisioning can vary depending on the specific drive model, the wear on the drive, and the planned workload for the drive.

According to certain non-limiting examples, the systems and methods disclosed herein dynamically adjust the amount of over-provisioning for drives allocated for a particular service. The amount of over-provisioning can depend on predictions and/or measurements of the write usage (or write profile) of the service. Additionally or alternatively, the amount of over-provisioning can depend on the type of drive (e.g., drive specifications and/or measurements). Dynamically adjusting the amount of over-provisioning can ensure that the drive is optimally provisioned to meet the specific workload and endurance requirements of the service for which the drive has been allocated. The systems and methods disclosed herein can account for the prior workloads on the drive and the usage patterns of the service when predicting the optimal parameters (e.g., amount of over-provisioning) customized for a particular service.

According to certain non-limiting examples, the systems and methods disclosed herein dynamically adjust the NVMe namespace size or over-provisioning when initiating/provisioning a drive (and corresponding server). For example, the amount of over-provisioning can be based on the drive's current write usage and the lifetime rated endurance. Additionally or alternatively, the amount of over-provisioning can be based on the performance and capacity requirements for the workload that the drive will be used for.

According to certain non-limiting examples, the system monitors the drive's write usage and compares it to the lifetime-rated endurance. If the write usage is approaching the lifetime-rated endurance, the system can dynamically increase the amount of over-provisioning to help extend the drive's lifespan. Conversely, if the write usage is low and there is excess over-provisioning, the system can decrease the amount of over-provisioning to provide more usable capacity available to store user data.

According to certain non-limiting examples, when there is a very high-performance workload that does not utilize much capacity, the optimal amount of over-provisioning can be large. For example, the systems and methods disclosed herein can enhance the performance and/or extend the life of SSDs by selecting different over-provisioning amounts for different services. Further, upon receiving a request for a particular service, a cloud-based storage system can instantiate the service by selecting one or more drives from a free pool of drives, and the cloud-based storage system can initiate/configure the drives that are selected to provide the service to have an amount of over-provisioning that is selected based on a description of the service (and optionally based on attributes of the drive). Increasing the amount of over-provisioning can help to mitigate write amplification, but the impact and amount of write amplification (i.e., the write amplification factor (WAF)) can vary depending on the service.

According to certain non-limiting examples, the amount of over-provisioning can be set higher for services that have heavy write workloads, have a higher number/percentage of random writes, or have lower capacity requirements. The amount of over-provisioning can be set lower for services that have light write workloads, have a lower number/percentage of random writes, or have greater capacity requirements. For example, some services are read-heavy but light with respect to write operations. In this case, a lower amount of over-provisioning might be acceptable because even with a higher write amplification factor (WAF) the drive writes per day (DWPD) will still be below the drive specifications. Further, some services can use mostly sequential reads and therefore can have a smaller WAF, such that increasing the amount of over-provisioning might have less of an effect than for services that mostly use random writes.

SSDs are subject to write amplification, which occurs when the actual number of write operations (i.e., the amount of data written to the storage medium) is greater than the number of host write operations (i.e., the amount of user data intended to be written). Write amplification results from the way SSDs manage data (e.g., wear leveling and garbage collection). For example, when a user modifies a small file, the SSD may need to read the entire block containing that file, modify the block, and write the entire block back to the drive, rather than just writing the modified data.

Each write operation counts toward the SSD's endurance rating (measured in P/E cycles). High write amplification means that the SSD may reach its write endurance limit more quickly than expected, potentially leading to premature failure. For instance, if a drive has a TBW rating of 150 TB but experiences a write amplification factor (WAF) of 3, the actual write limit could be reached after only 50 TB of user data is written.

According to certain non-limiting examples, the systems and methods disclosed herein that provide dynamic adjustment for the amount of over-provisioning can be used for cloud-based storage in a content management system. Content management systems can use a data storage system, such as MAGIC POCKET by DROPBOX. The data storage system can provide several operations that can be ongoing simultaneously, and each of these operations can represent different workloads that are allocated to different drives and servers.

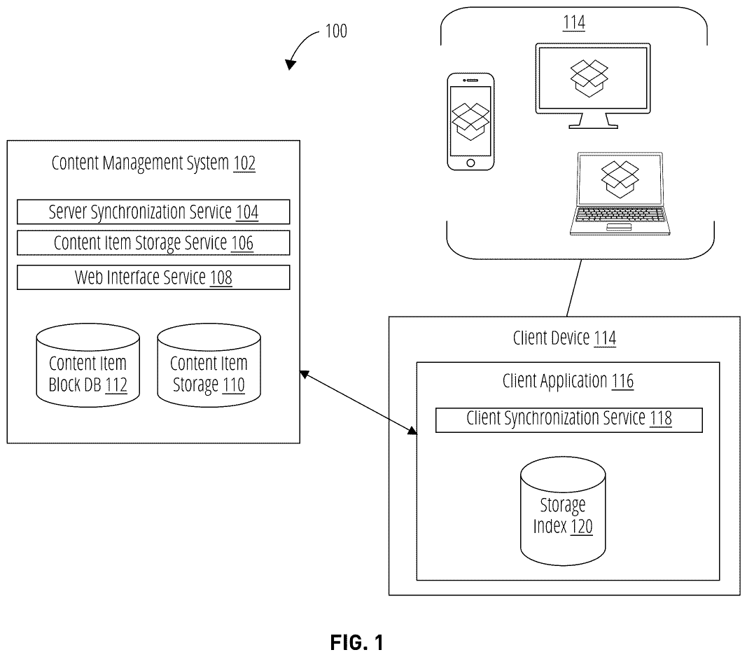

In some embodiments the disclosed technology is deployed in the context of a content management system having content item synchronization capabilities and collaboration features, among others. An example system configuration 100 is shown in FIG. 1, which depicts content management system 102 interacting with client device 114. Although the example system depicts particular system components and an arrangement of such components, this depiction is to facilitate a discussion of the present technology and should not be considered limiting unless specified in the appended claims. For example, some components that are illustrated as separate can be combined with other components, some components can be divided into separate components, some components might not be present or needed, and additional components may be present.

### Accounts

Content management system 102 can store content items in association with accounts, as well as perform a variety of content item management tasks, such as retrieve, modify, browse, and/or share the content item(s). Furthermore, content management system 102 can enable an account to access content item(s) from multiple client devices.

Content management system 102 supports a plurality of accounts. A subject (user, group, team, company, etc.) can create an account with content management system.

### Content Item Storage

A feature of content management system 102 is the storage of content items, which can be stored in content item storage 110. A content item generally is any entity that can be recorded in a file system. Content items can be any object including digital data such as documents, collaboration content items, text files, audio files, image files, video files, webpages, executable files, binary files, content item directories, folders, zip files, playlists, albums, symlinks, cloud docs, mounts, placeholder content items referencing other content items in content management system 102 or in other content management systems, etc.

In some embodiments, content items can be grouped into a collection, which can refer to a folder including a plurality of content items, or a plurality of content items that are related or grouped by a common attribute.

In some embodiments, content item storage 110 is combined with other types of storage or databases to handle specific functions. Content item storage 110 can store content items, while metadata regarding the content items can be stored in a metadata database. Likewise, data regarding where a content item is stored in content item storage 110 can be stored in content item block database 112. Thus, content management system 102 may include more or less storages and/or databases than shown in FIG. 1.

In some embodiments, content item storage 110 is associated with at least one content item storage service 106, which includes software or other processor executable instructions for managing the storage of content items including, but not limited to, receiving content items for storage, preparing content items for storage, selecting a storage location for the content item, retrieving content items from storage, etc. In some embodiments, content item storage service 106 can divide a content item into smaller chunks for storage at content item storage 110. The location of each chunk making up a content item can be recorded in content item block database 112. Content item block database 112 can include a content entry for each content item stored in content item storage 110. The content entry can be associated with a content item ID, which uniquely identifies a content item.

In some embodiments, content items and chunks of content items can also be identified from a deterministic hash function. This method of identifying a content item and chunks of content items can ensure that content item duplicates are recognized as such since the deterministic hash function will output the same hash for every copy of the same content item, but will output a different hash for a different content item. Using this methodology, content item storage service 106 can output a unique hash for each different version of a content item.

Content item storage service 106 can also designate or record a parent of a content item or a content path for a content item. The content path can include the name of the content item and/or folder hierarchy associated with the content item. For example, the content path can include a folder or path of folders in which the content item is stored in a local file system on a client device. In some embodiments, content item database might only store a direct ancestor or direct child of any content item, which allows a full path for a content item to be derived, and can be more efficient than storing the whole path for a content item.

While content items are stored in content item storage 110 in blocks and may not be stored under a tree like directory structure, such directory structure is a comfortable navigation structure for subjects viewing content items. Content item storage service 106 can define or record a content path for a content item wherein the “root” node of a directory structure can be any directory with specific access privileges assigned to it, as opposed to a directory that inherits access privileges from another directory.

In some embodiments, a root directory can be mounted underneath another root directory to give the appearance of a single directory structure. This can occur when an account has access to a plurality of root directories. As addressed above, the directory structure is merely a comfortable navigation structure for subjects viewing content items, but does not correlate to storage locations of content items in content item storage 110.

While the directory structure in which an account views content items does not correlate to storage locations of the content items at content management system 102, the directory structure can correlate to storage locations of the content items on client device 114 depending on the file system used by client device 114.

As addressed above, a content entry in content item block database 112 can also include the location of each chunk making up a content item. More specifically, the content entry can include content pointers that identify the location in content item storage 110 of the chunks that make up the content item.

Content item storage service 106 can decrease the amount of storage space required by identifying duplicate content items or duplicate blocks that make up a content item or versions of a content item. Instead of storing multiple copies, content item storage 110 can store a single copy of the content item or block of the content item, and content item block database 112 can include a pointer or other mechanism to link the duplicates to the single copy.

Content item storage service 106 can also store metadata describing content items, content item types, folders, file path, and/or the relationship of content items to various accounts, collections, or groups, in association with the content item ID of the content item.

Content item storage service 106 can also store a log of data regarding changes, access, etc.

### Content Item Synchronization

Another feature of content management system 102 is synchronization of content items with at least one client device 114. Client devices 114 can take different forms and have different capabilities. For example, client device 114 can be a computing device having a local file system accessible by multiple applications resident thereon. Client device 114 can be a computing device wherein content items are only accessible to a specific application or by permission given by the specific application, and the content items are typically stored either in an application specific space or in the cloud. Client device 114 can be any client device accessing content management system 102 via a web browser and accessing content items via a web interface. While example client device 114 is depicted in form factors such as a laptop, mobile device, or web browser, it should be understood that the descriptions thereof are not limited to devices of these example form factors. For example, a mobile device might have a local file system accessible by multiple applications resident thereon or might access content management system 102 via a web browser. As such, the form factor should not be considered limiting when considering client device 114's capabilities. One or more functions described herein with respect to client device 114 may or may not be available on every client device depending on the specific capabilities of the device—the file access model being one such capability.

In many embodiments, client devices 114 are associated with an account of content management system 102, but in some embodiments client device 114 can access content using shared links and do not require an account.

As noted above, some client devices can access content management system 102 using a web browser. However, client devices can also access content management system 102 using client application 116 stored and running on client device 114. Client application 116 can include a client synchronization service 118.

Client synchronization service 118 can be in communication with server synchronization service 104 to synchronize changes to content items between client device 114 and content management system 102.

Client device 114 can synchronize content with content management system 102 via client synchronization service 118. The synchronization can be platform agnostic. That is, content can be synchronized across multiple client devices of varying types, capabilities, operating systems, etc. Client synchronization service 118 can synchronize any changes (e.g., new, deleted, modified, copied, or moved content items) to content items in a designated location of a file system of client device 114.

Content items can be synchronized from client device 114 to content management system 102, and vice versa. In embodiments wherein synchronization is from client device 114 to content management system 102, a subject can manipulate content items directly from the file system of client device 114, while client synchronization service 118 can monitor directory on client device 114 for changes to files within the monitored folders.

When client synchronization service 118 detects a write, move, copy, or delete of content in a directory that it monitors, client synchronization service 118 can synchronize the changes to content item storage service 106. In some embodiments, client synchronization service 118 can perform some functions of content item storage service 106 including functions addressed above such as dividing the content item into blocks, hashing the content item to generate a unique identifier, etc. Client synchronization service 118 can index content within client storage index 120 and save the result in client storage index 120. Indexing can include storing paths plus the content item identifier, and a unique identifier for each content item. In some embodiments, client synchronization service 118 learns the content item identifier from server synchronization service 104, and learns the unique client identifier from the operating system of client device 114.

Client synchronization service 118 can use storage index 120 to facilitate the synchronization of at least a portion of the content items within client storage with content items associated with a subject account on content management system 102. For example, client synchronization service 118 can compare storage index 120 with content management system 102 and detect differences between content on client storage and content associated with a subject account on content management system 102. Client synchronization service 118 can then attempt to reconcile differences by uploading, downloading, modifying, and deleting content on client storage as appropriate.

In some embodiments, storage index 120 stores tree data structures wherein one tree reflects the latest representation of a directory according to server synchronization service 104, while another tree reflects the latest representation of the directory according to client synchronization service 118. Client synchronization service 118 can work to ensure that the tree structures match by requesting data from server synchronization service 104 or committing changes on client device 114 to content management system 102.

Sometimes client device 114 might not have a network connection available. In this scenario, client synchronization service 118 can monitor the linked collection for content item changes and queue those changes for later synchronization to content management system 102 when a network connection is available. Similarly, a subject can manually start, stop, pause, or resume synchronization with content management system 102.

Client synchronization service 118 can synchronize all content associated with a particular subject account on content management system 102. Alternatively, client synchronization service 118 can selectively synchronize some of the content items associated with the particular subject account on content management system 102. Selectively synchronizing only some of the content items can preserve space on client device 114 and save bandwidth.

In some embodiments, client synchronization service 118 selectively stores a portion of the content items associated with the particular subject account and stores placeholder content items in client storage for the remainder portion of the content items. For example, client synchronization service 118 can store a placeholder content item that has the same filename, path, extension, metadata, of its respective complete content item on content management system 102, but lacking the data of the complete content item. The placeholder content item can be a few bytes or less in size while the respective complete content item might be significantly larger. After client device 114 attempts to access the content item, client synchronization service 118 can retrieve the data of the content item from content management system 102 and provide the complete content item to client device 114. This approach can provide significant space and bandwidth savings while still providing full access to a subject's content items on content management system 102.

While the synchronization embodiments addressed above referred to client device 114 and a server of content management system 102, it should be appreciated by those of ordinary skill in the art that a user account can have any number of client devices 114 all synchronizing content items with content management system 102, such that changes to a content item on any one client device 114 can propagate to other client devices 114 through their respective synchronization with content management system 102.

### Content Item Access

Content item storage service 106 can receive a token from client application 116 that follows a request to access a content item and can return the capabilities permitted to the subject account.

In some embodiments, one or more of the services or storages/databases discussed above can be accessed using public or private application programming interfaces.

Certain software applications can access content item storage 110 via an API on behalf of a subject. For example, a software package such as an application running on client device 114, can programmatically make API calls directly to content management system 102 when a subject provides authentication credentials, to read, write, create, delete, share, or otherwise manipulate content.

A subject can view or manipulate content stored in a subject account via a web interface generated and served by web interface service 108. For example, the subject can navigate in a web browser to a web address provided by content management system 102. Changes or updates to content in the content item storage 110 made through the web interface, such as uploading a new version of a content item, can be propagated back to other client devices associated with the subject's account. For example, multiple client devices, each with their own client software, can be associated with a single account and content items in the account can be synchronized between each of the multiple client devices.

Client device 114 can connect to content management system 102 on behalf of a subject. A subject can directly interact with client device 114, for example when client device 114 is a desktop or laptop computer, phone, television, internet-of-things device, etc. Alternatively or additionally, client device 114 can act on behalf of the subject without the subject having physical access to client device 114, for example when client device 114 is a server.

Some features of client device 114 are enabled by an application installed on client device 114. In some embodiments, the application can include a content management system specific component. For example, the content management system specific component can be a stand-alone client application 116, one or more application plug-ins, and/or a browser extension. However, the subject can also interact with content management system 102 via a third-party application, such as a web browser, that resides on client device 114 and is configured to communicate with content management system 102. In various implementations, the client application 116 can present a subject interface (UI) for a subject to interact with content management system 102. For example, the subject can interact with the content management system 102 via a file system explorer integrated with the file system or via a webpage displayed using a web browser application.

In some embodiments, client application 116 can be configured to manage and synchronize content for more than one account of content management system 102. In such embodiments client application 116 can remain logged into multiple accounts and provide normal services for the multiple accounts. In some embodiments, each account can appear as folder in a file system, and all content items within that folder can be synchronized with content management system 102. In some embodiments, client application 116 can include a selector to choose one of the multiple accounts to be the primary account or default account.

### Third Party Services

In some embodiments content management system 102 can include functionality to interface with one or more third party services such as workspace services, email services, task services, etc. In such embodiments, content management system 102 can be provided with login credentials for a subject account at the third party service to interact with the third party service to bring functionality or data from those third party services into various subject interfaces provided by content management system 102.

While content management system 102 is presented with specific components, it should be understood by one skilled in the art, that the architectural system configuration 100 is simply one possible configuration and that other configurations with more or fewer components are possible. Further, a service can have more or less functionality, even including functionality described as being with another service. Moreover, features described herein with respect to an embodiment can be combined with features described with respect to another embodiment.

While system configuration 100 is presented with specific components, it should be understood by one skilled in the art, that system configuration 100 is simply one possible configuration and that other configurations with more or fewer components are possible.

### System Architecture

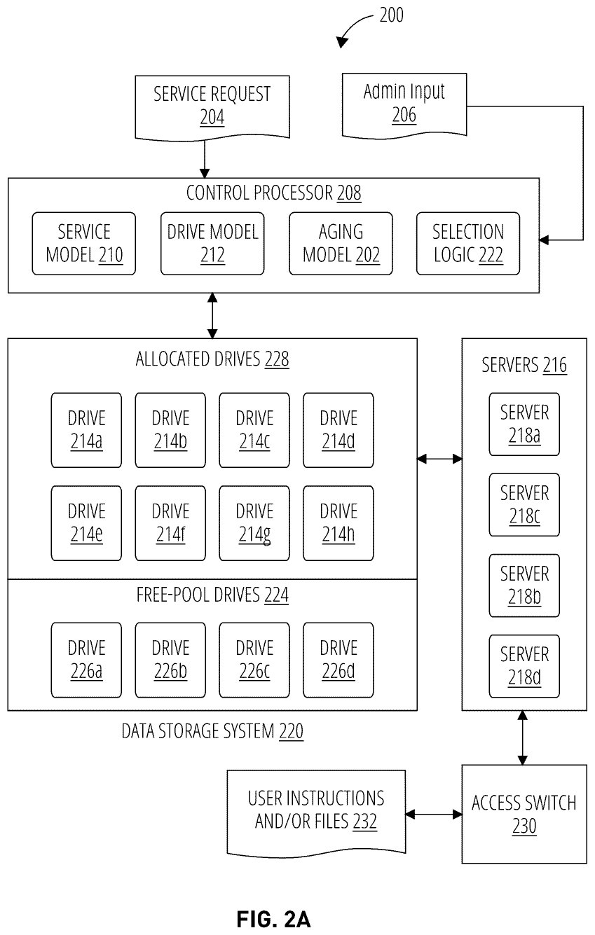

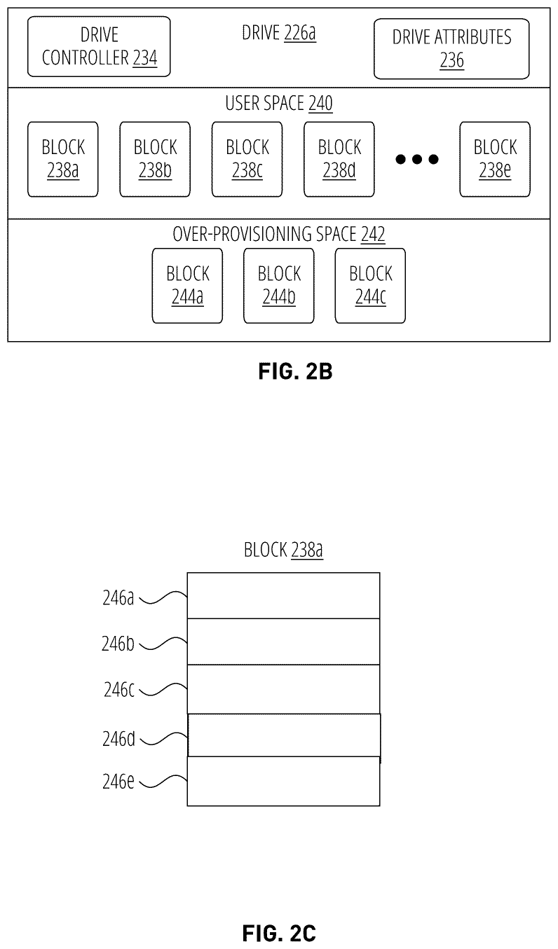

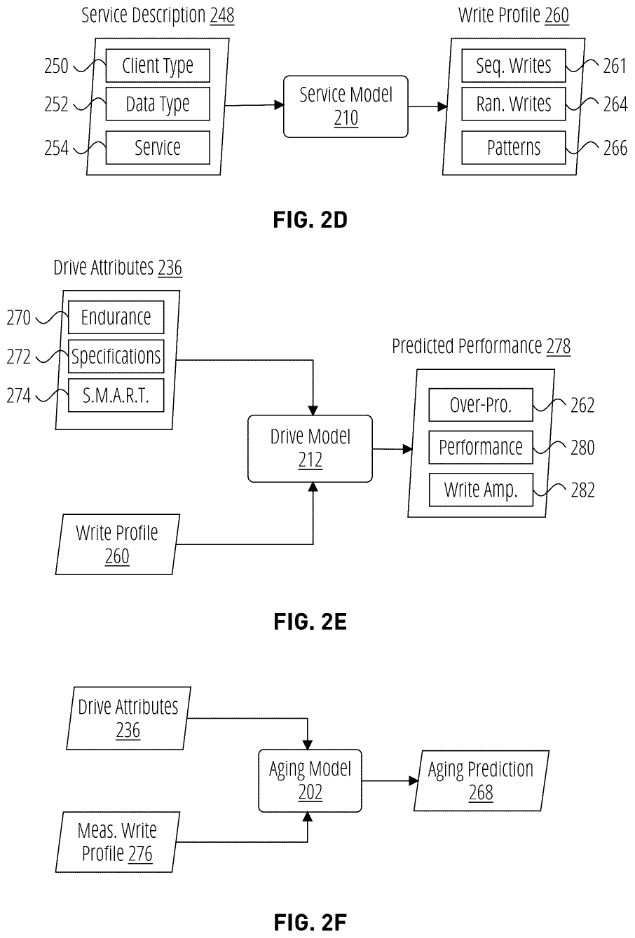

FIG. 2A illustrates a non-limiting example of system 200, in which control processor 208 manages service requests (e.g., service request 204) to data storage system 220. For example, system 200 can be a data center that includes various switches, routers, firewall appliances, servers and computer-readable storage devices (i.e., drives). According to certain non-limiting examples, system 200 can be a file-sharing service that uses data storage system 220 to store the user files that can be shared and synchronized as described for FIG. 1. Additionally or alternatively, system 200 can be a cloud-based service that uses a cloud-based storage system, and the cloud-based service can be, e.g., infrastructure as a service (IaaS), software as a service (SaaS), platform as a service (PaaS), etc.

System 200 can be used to provide different services to different users, and these different services can be hosted on different servers 216 and store data on different allocated drives 228. For example, a first user who is subscribed to a first service can provide user instructions and/or files 232, which is routed through access switch 230 to one of the servers 216 (e.g., server 218b, server 218c, or server 218d). Data for the first service can be stored on a first set of allocated drives 228 (e.g., drive 214a, drive 214b, and drive 214c). Additionally, a second user who is subscribed to a second service can provide user instructions and/or files 232, which are routed through access switch 230 to one of the servers 216 (e.g., server 218a). Data for the second service can be stored on a second set of allocated drives 228 (e.g., drive 214d, drive 214e, and drive 214f). The remaining allocated drives (i.e., drive 214g and drive 214h) can be used for other services.

Free-pool drives 224 can be drives that are not currently allocated to any service. When additional storage is requested (e.g., a new service is deployed or an existing service requests additional data storage), one of the drives in free-pool drives 224 (e.g., drive 226a, drive 226b, drive 226c, or drive 226d) can be allocated and initialized for the requested service, becoming part of allocated drives 228. Control processor 208 receives service request 204 and determines which of the drives in free-pool drives 224 and sets parameters for the initialization of the selected drive. These parameters for the initialization of the selected drive can include, e.g., an amount of over-provisioning.

The selection of the drive and the parameters can be performed using selection logic 222. Selection logic 222 can analyze various factors in selecting the drive and the parameters, and these factors can include information about the service provided in service request 204 and objective instructions included in admin input 206. For example, the amount of over-provisioning can depend on whether the service indicated in service request 204 is predicted by service model 210 to have a high write usage, a medium write usage, or a low write usage, relative to a rating of the selected drive. For example, a high write usage can be when the predicted number of writes per day is greater than N times the drive rating, and a low write usage can be when the predicted number of writes per day is less than the drive rating divided by M, where N and M are predefined numbers greater one (e.g., but not limited to N=M=1.7, N=M=2, N=M=3, or N=M=4). For example, an upper value can be used for the over-provisioning for services having a high write usage, a lower value can be used for the over-provisioning for services having a low write usage, and the amount of over-provisioning can be between the low value and the high value for services having a medium write usage. For example, for a medium write usage, the over-provisioning amount can be a continuous or stepwise increasing monotonic function of the predicted write usage.

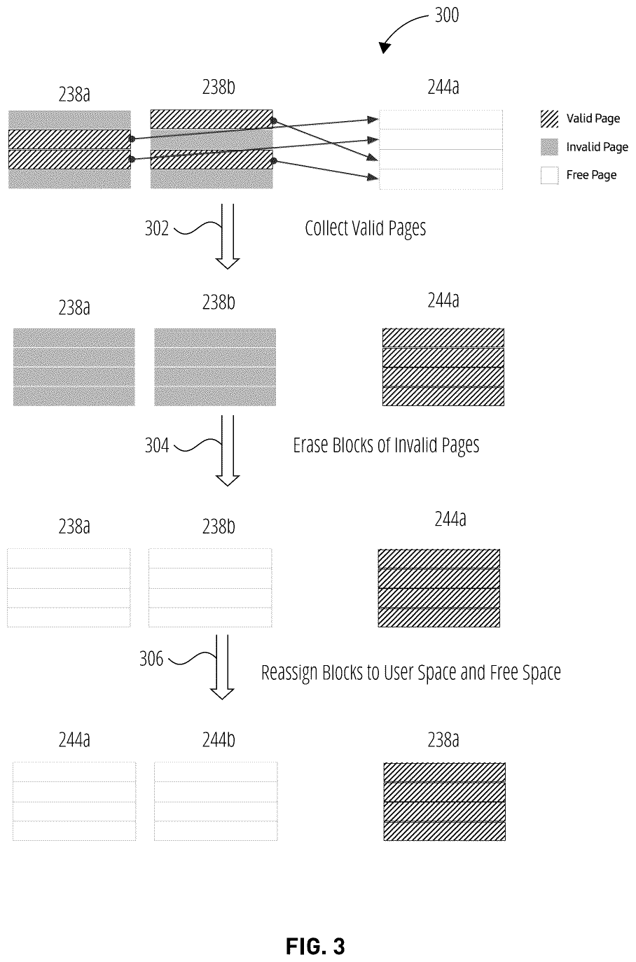

As discussed below, solid-state drives experience write amplification in which for each host write (i.e., a write initiated by the host controller), there can be additional writes performed by the drive controller due to data management operations such as wear leveling and garbage collection. Garbage collection can be more efficient when there is more free space (i.e., free blocks) on the drive, which can be used for garbage collection. Garbage collection refers to a data management operation in which valid pages on blocks, which also include invalid pages, are collected to the free block, as discussed below for FIG. 3. Increasing the amount of over-provisioning increases the amount of dedicated free space (i.e., more free blocks for garbage collection) thereby reducing the write amplification factor (WAF) and extending the life of the drive. However, there is a tradeoff between using over-provisioning to decrease write amplification and the available storage capacity of the drive because increasing the amount of over-provisioning (i.e., the dedicated free space) decreases the user space that is available to write user data to the drive (i.e., the available storage capacity of the drive). The optimal amount of over-provisioning can depend on the service provided using the drive and the amount of write usage corresponding to the service.

As discussed below, service model 210 uses inputs from service request 204 to predict performance aspects of the service, such as the write usage. Drive model 212 can predict the drive performance (e.g., the WAF) in response to the write profile 260 from service model 210. For example, drive model 212 can predict the WAF for a given choice of over-provisioning and predicted write profile. Selection logic 222 can use the outputs from service model 210 and drive model 212 to select the drive and the initialization parameters (e.g., over-provisioning amount) to provide the service indicated by service request 204.

Further, selection logic 222 can select the drive and the initialization parameters based on admin input 206 and drive parameters. For example, drive 226a and drive 226b can have a scheduled replacement day, and admin input 206 can include instructions that the predicted end of life should not occur before the scheduled replacement day. Further, statistics stored on free-pool drives 224 can indicate that drive 226a has performed more writes over its life than drive 226b, but the two drives are otherwise identical. In view of this information, selection logic 222 can select drive 226a for a less write-heavy service than drive 226b. Additionally or Alternatively, if both drive 226a and drive 226b are used for the same service, the over-provisioning amount can be greater for drive 226a than for drive 226b to preserve the remaining life of drive 226a until the scheduled replacement day.

The above is a non-limiting example of how selection logic 222 can use admin input 206 and outputs from service model 210 and drive model 212 to select the drive and the initialization parameters for a given service. A person of ordinary skill in the art will recognize that the selection made by selection logic 222 can be informed by other types of instructions in admin input 206 and other inputs and outputs can be used for service model 210 and drive model 212. Further, selection logic 222 can be directed to other goals, including improving read and write performance to the drives (e.g., throughput and reducing latency), evening wear uniformity among the drives, managing thermal properties, etc.

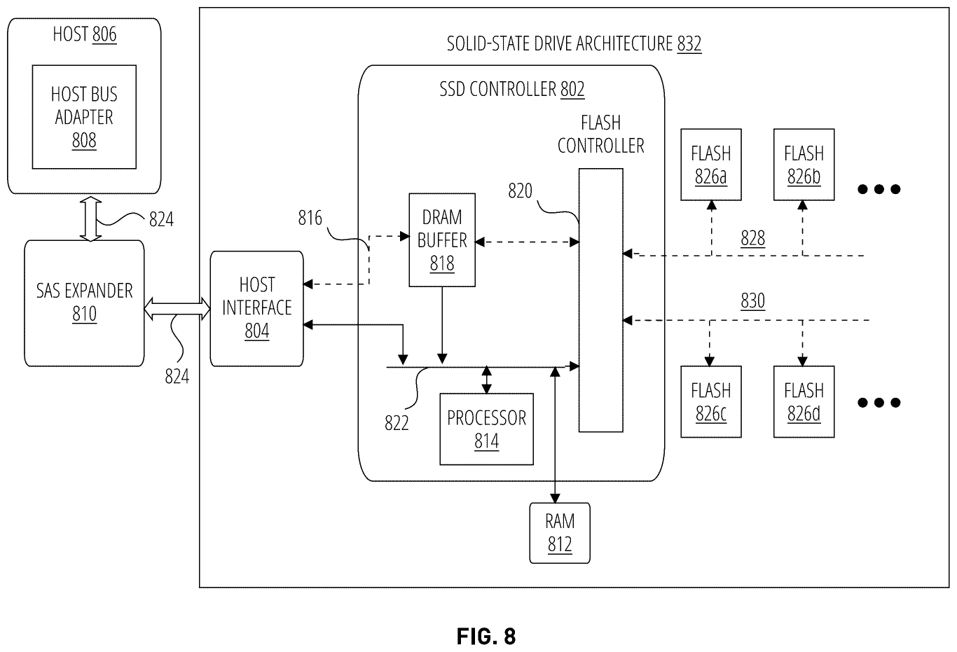

FIG. 2B illustrates a non-limiting example of a drive (e.g., drive 226a) from system 200. In addition to the blocks for storing data, the drive includes drive controller 234 and drive attributes 236. Drive 226a can be a solid-state drive (SSD), and drive controller 234 can be an SSD controller, such as SSD controller 802 discussed below for FIG. 8. Drive attributes 236 can be historical data for the drive, specifications of the drive, and S.M.A.R.T. attributes 274, for example.

The memory on drive 226a is subdivided into blocks, which are further subdivided into pages. The drive can include user space 240 that includes a first set of blocks (e.g., block 238a, block 238b, block 238c, block 238d, through block 238e) and include a free space or over-provisioning space 242 that includes a second set of blocks (e.g., block 244a, block 244b, and block 244c).

Over-provisioning refers to a function that secures extra space to allow for efficient use of the SSD by allocating a certain number of blocks of the SSD (e.g., a certain percentage of the NAND flash) to an over-provisioning space (e.g., over-provisioning space 242). Over-provisioning space 242 consists of free blocks that can only be accessed by the SSD controller and not by the host. Over-provisioning space 242 assists in the efficient delivery of free blocks when wear-leveling or garbage collection is in progress and contributes to improved performance and lifetime of the SSD.

Over-provisioning space 242 is an amount of memory that is set aside to remain free to facilitate various functions such as garbage collection. According to certain non-limiting examples, the controller keeps track of which physical blocks are used and which are free. As illustrated in FIG. 3, during garbage collection, e.g., when a first block has both valid pages and invalid pages, the invalid pages can be collected and written to a free block which is a free block, after which the first block is erased. For NAND flash, the write operation is referred to as programming, and the write/erase cycle is referred to as a program/erase (P/E) cycle. The general term “write” refers to both the program operation in SSDs and write operations in other types of drives. When “write” is used for SSDs and NAND flash it refers to the program operation.

The controller keeps track of which blocks are free and used. For example, after the garbage collection described above, drive controller 234 can mark the first block as free and the second block as used. By setting the amount of space reserved for over-provisioning space 242, a minimum bound is set for the number of free blocks that are available to facilitate garbage collection and other functions of the SSD.

That is, over-provisioning refers to allocating extra physical storage space beyond the user-visible capacity to enhance performance and longevity. The physical blocks in an SSD are divided into user space (where user data is stored) and free space (reserved for wear leveling and garbage collection).

For example, drive controller 234 can manage transitions of blocks between free space and user space using the following operations: write operations, delete operations, garbage collection wear leveling. In write operations, new data can be written to empty (free) blocks. The controller identifies available blocks and allocates them for user data. When data is deleted, the SSD does not immediately erase the physical blocks where the data was stored. Instead, it marks these blocks as invalid. The data remains in place until the SSD performs a garbage collection process. Garbage collection identifies blocks that contain invalid data (data marked for deletion) and reclaims them. The SSD controller reads the valid data from these blocks, writes it to a new location, and then erases the invalid blocks, making them available again as free space. Wear leveling extends the lifespan of the SSD, the controller also employs wear leveling techniques, ensuring that write and erase cycles are distributed evenly across all blocks, preventing any single block from wearing out prematurely.

FIG. 2C illustrates a non-limiting example of a block (e.g., block 238a) being subdivided into pages (e.g., page 246a, page 246b, page 246c, page 246d, and page 246e).

FIG. 2D illustrates a non-limiting example of inputs and outputs of service model 210. For example, service model 210 can receive service description 248 as an input and generate write profile 260 as an output. Service description 248 can include information that is relevant for determining a write profile 260 of a service. Examples of relevant information can include client type 250, data type 252, and service 254.

Regarding client type 250, a banking-type client might have a different write profile 260 from a hospital-type client, which is different from an engineering-type client. The mapping between respective client types and their corresponding write profiles can be manually defined or can be learned (e.g., using machine learning) from historical data, representing actual clients and their associated write profiles.

Regarding data type 252, the type of data can also correlate with the write profile. For example, video surveillance data might be written predictably a certain times, stored for a set length of time, and then deleted according to a predefined schedule, representing a first characteristic write profile. Additionally, backing up financial records can also be scheduled to operate outside of normal work hours, representing a second characteristic write profile. Shared text documents for collaborations at a research institution might correlate with a third characteristic write profile.

Regarding data type 252, service 254, various types of services (e.g., IaaS, PaaS, and SaaS), service agreements, and contractual arrangements might correlate with different write profiles.

Service model 210 can be manually programmed to predict write profiles 260 based on service descriptions 248. Additionally or alternatively, service model 210 can use machine learning (ML) to learn latent patterns in service description 248 that are predictive of write profiles 260.

Write profiles 260 can include various information that is relevant to optimizing the selection of a drive for a given service and/or the initialization/configuration of a drive for said service, including, e.g., the over-provisioning amount 262, the number of random writes 264, and patterns 266.

Patterns 266 can be cyclical or statistical patterns for when the SSD is as accessed and written to. For example, some services might experience groupings in which many writes occur over a short period followed by periods of less frequent writes. For example, some industries might require many writes on Mondays and then fewer writes the rest of the work days, and almost no writes on weekends.

Sequential writes 261 are when data is written in a continuous sequence (i.e., the write operations are to consecutive memory locations). Sequential writes 261 can be faster the random writes 264 by leveraging the SSD architecture to efficiently write data in larger chunks. Sequential writes 261 can occur, e.g., when writing a large video file or performing bulk data transfers.

Random writes 264 are when data is written to non-contiguous memory locations. Random writes 264 are slower due to the overhead of seeking different memory locations and potentially more read/modify/write cycles. Random writes 264 tend to occur when writing small files or performing database updates where data is scattered across the drive.

The over-provisioning amount 262 and the number of random writes 264 can affect write amplification in which the actual number of writes to the SSD exceeds the number of host writes (e.g., user data intended to be written), which results from the SSD managing data (e.g., wear leveling and garbage collection). Sequential writes can result in lower write amplification because data can be written efficiently in large blocks, resulting in fewer read/modify/write cycles because the SSD can write new data to free blocks without needing to rearrange existing data. Random writes tend to cause higher write amplification because the SSD may have to read existing blocks, modify them to include the new data, and then write the entire block again. This process can lead to more frequent garbage collection, increasing the number of drive writes.

According to certain non-limiting examples, write profile 260 can include a collective/comprehensive write usage metric rather than separate values for over-provisioning amount 262 and random writes 264.

FIG. 2E illustrates a non-limiting example of inputs and outputs of drive model 212. For example, drive model 212 can receive drive attributes 236 and write profile 260 as an input and generate predicted performance 278 as an output. Drive attributes 236 can include information about the drive that is relevant for determining predicted performance 278 of the drive performing the service. Examples of drive attributes 236 can include endurance 270, specifications 272, and S.M.A.R.T. attributes 274. Examples of predicted performance 278 can include over-provisioning amount 262, performance 280, and write amplification 282.

Drive model 212 can be manually programmed (e.g., based on an empirical formula) to determine predicted performance 278 based on drive attributes 236 and write profile 260. Additionally or alternatively, drive model 212 can use machine learning (ML) to learn latent patterns in drive attributes 236 and write profile 260 that are predictive of the drive performance.

Endurance 270 refers the ability of an SSD to withstand a specified number of program/erase (P/E) cycles before the memory cells wear out. Each time data is written to or erased from the flash memory, it undergoes a P/E cycle, and over time, the memory cells can become less reliable. Endurance can be expressed in terms of terabytes written (TBW) or drive writes per day (DWPD) over a specified warranty period (e.g., 3 to 5 years). For example, an SSD with a TBW rating of 150 TB means it can reliably handle 150 terabytes of data written before significant wear occurs.

The endurance 270 for a given drive can depend on the type of NAND flash used. For example, single-level cell (SLC) flash can have the highest endurance, typically rated for tens of thousands of P/E cycles, multi-level cell (MLC) flash can have moderate endurance, often rated for a few thousand P/E cycles, and triple-level cell (TLC) and quad-level cell (QLC) flash can have lower endurance.

Factors that can affect the lifetime of the drive and how quickly the drive reaches its specified endurance value, e.g., reaches its end of life (EOL) include write patterns, wear leveling, and over-provisioning. Write patterns impact how quickly an SSD reaches its EOL because frequent random writes can lead to higher write amplification and faster wear. Efficient wear leveling algorithms can distribute write and erase cycles more evenly across the SSD, enhancing overall endurance. Over-provisioning provides additional reserved space that mitigates wear by providing extra blocks for the SSD controller to manage.

Specifications 272 are the specification of the drive. In addition to endurance 270, examples of specifications 272 include, e.g., capacity, form factor, interface, read and write speeds, random read/write input/output operations per second (IOPS), latency, and power consumption. Capacity is the total storage space available on the SSD, which can be measured in gigabytes (GB) or terabytes (TB). Form factor is the physical size and shape of the SSD. For example, form factors can include 2.5-inch, M.2, and PCIe add-in cards. Interface refers to the connection type between the SSD and the motherboard, including, e.g., Serial Advanced Technology Attachment (SATA), NVMe (PCIe), and Serial Attached SCSI (SAS). Read and write speeds are the maximum data transfer rates for reading and writing data, which can be measured in megabytes per second (MB/s) or gigabytes per second (GB/s). Random Read/Write IOPS indicates how many read and write operations can be performed per second. Latency is the time it takes to execute a read or write command, which can be measured in microseconds (s). Power consumption is the amount of power the SSD consumes during operation and idle states, which can be measured in watts (W).

The term “S.M.A.R.T.” refers to Self-Monitoring, Analysis, and Reporting Technology, which is a system built into SSDs and HDDs that monitors various attributes to predict potential drive failures and assess health. S.M.A.R.T. attributes 274 provide information about the health and performance of SSDs. Monitoring these attributes can help users take proactive measures to avoid data loss and maintain optimal SSD performance. Understanding these metrics can guide users in making informed decisions about when to replace or upgrade their drives. Table 1 (below) provides a non-limiting list of examples of S.M.A.R.T. attributes 274.

TABLE 1
examples of S.M.A.R.T. attributes 274

| | S.M.A.R.T. Attributes | |
|---|---|---|
| ID | Attribute name | Status Flag |
| 5 | Reallocated Sector Count | 110011 |
| 9 | Power-on Hours | 110010 |
| 12 | Power-on Count | 110010 |
| 177 | Wear Leveling Count | 010011 |
| 179 | Used Reserved Block Count (total) | 010011 |
| 180 | Unused Reserved Block Count (total) | 010011 |
| 181 | Program Fail Count (total) | 110010 |
| 182 | Erase Fail Count (total) | 110010 |
| 183 | Runtime Bad Count (total) | 010011 |
| 184 | End to End Error data path Error count | 110011 |
| 187 | Uncorrectable Error Count | 110010 |
| 190 | Airflow Temperature | 110010 |
| 194 | Temperature | 100010 |
| 195 | ECC Error Rate | 011010 |
| 197 | Pending Sector Count | 110010 |
| 199 | CRC Error Count | 111110 |
| 202 | SSD Mode Status | 110011 |
| 235 | POR Recovery Count | 010010 |
| 241 | Total LBAs Written | 110010 |
| 242 | Total LBAs Read | 110010 |
| 243 | SATA Downshift Control | 110010 |
| 244 | Thermal Throttle Status | 110010 |
| 245 | Timed Workload Media Wear | 110010 |
| 246 | Timed Workload Host Read/Write Ratio | 110010 |
| 247 | Timed Workload Timer | 110010 |
| 251 | NAND Writes | 110010 |

Power-On Hours (POH) measures the total time the SSD has been powered on. Wear leveling count indicates the average number of PIE cycles used across all memory cells. A higher count suggests that wear leveling is effectively distributing writes. The reallocated sector count is the number of bad sectors that have been reallocated to spare sectors. A high value may indicate impending failure. The uncorrectable errors metric tracks the number of errors that could not be corrected. A rising count may signal potential failure. Temperature monitors the current temperature of the SSD. High temperatures can affect performance and longevity.

In Table 1, ID-241 and ID-251 indicate the write amount of the host and NAND, respectively, and these can be used to calculate the WAF of the SSD. ID-177 indicates the number of wear-leveling operations and can also be interpreted as the overall average for program/erase cycles, which together with the WAF value can be used to calculate the drive writes per day (DWPD). ID-247 represents the time in seconds that the SSD has been in operation since the workload timer was started, and starting/stopping the timer can be controlled by a user/administrator via the SSD software tools. ID-246 shows the share of I/O operations that were read commands since the workload timer (ID-247) was started and is expressed as a percentage. ID-245 measures the wear of the SSD given the workload (ID-246) and the period over which these workloads have been sustained (ID-247).

FIG. 2F illustrates a non-limiting example of inputs and outputs of drive aging model 202. For example, drive model 212 can receive drive attributes 236 and measured write profile 276 as an input and generate aging prediction 268 as an output. Drive attributes 236 can include information about the drive that is relevant for determining aging prediction 268 of the drive performing the service. Aging prediction 268 can include an estimate of the end of life of a drive.

Drive model 212 can be manually programmed (e.g., based on an empirical formula) to determine aging prediction 268 based on drive attributes 236 and write profile 260. Additionally or alternatively, drive model 212 can use machine learning (ML) to learn latent patterns in drive attributes 236 and write profile 260 that are predictive of the performance decrease of the drive and the end of life for the drive (e.g., when the performance of the drive decreases below a predetermined level. The rated endurance of the drive can be expressed in terms of terabytes written (TBW). For example, a drive with a TBW rating of 150 TB is estimated by the manufacturer to reliably handle 150 terabytes of data written before significant wear occurs.

The actual degree of wear for a given drive, however, may vary from this prediction depending, e.g., on the write profile. Even though the given drive may have reached the rated endurance, the life of the drive can be extended, if the actual degree of wear (e.g., the number of NAND blocks that have been marked as unusable due to wear) is less than a predefined threshold for retiring the drive. Thus, aging model 202 can be used to more accurately estimated the actual end of life, as opposed to the rated endurance. Further, aging model 202 can be used to extend the life of the drive without risking degrade performance for system 200.

The actual degree of wear can be predicted more accurately using measured write profile 276 and S.M.A.R.T. attributes 274 of drive attributes 236. For example, aging model 202 can be trained using historical data to learn correlations and/or latent patterns between measured write profiles of previous dives and measured indicia of wear on the previous drives. Thus, based on the similarity of measured write profile 276 to the measured write profiles in the historical data, the current drive corresponding to measured write profile 276 can be predicted to age similarly to those drives in the historical data that are similar (e.g., similar drives can have similar drive attributes 236 and similar measured write profiles). Further, S.M.A.R.T. attributes 274 of drive attributes 236 can include various indicia of the degree of wear for the current drive. Such indicia can include, e.g., the Reallocated Sector Count, the Runtime Bad Count, and the various error counts and fail counts in Table 1 (e.g., Program Fail Count, Erase Fail Count, Uncorrectable Error Count, ECC Error Rate, CRC Error Rate, etc.).

FIG. 3 illustrates a garbage collection 300, which results in write amplification. Wear leveling is another function that also results in write amplification.

SSDs store electrons on NAND cells when writing data. With NAND flash, the stored data cannot be overwritten when new data is stored or erased. The writing operations to an SSD are carried out on pages, whereas erasing operations are carried out on blocks. Consequently, multiple cycles of writing and erasing when managing data on the SSD.

Since overwriting is not possible with NAND flash, existing data must be erased before new data can be written to that cell. Erasing data takes longer than writing because write operations are carried out in pages while erase operations are executed in blocks (which include multiple pages). To alleviate this decrease in write performance, a process called garbage collection is implemented to create free blocks within the SSD.

Garbage collection 300 secures free blocks by collecting valid pages into a single location and erasing the blocks consisting of invalid pages. However, this may sometimes result in slower performance in the unexpected case that garbage collection interferes with the host write. Therefore, free space in the SSD is beneficial to avoid such conflicts. Over-provisioning allocates/reserves space to more efficiently perform data management tasks.

Garbage collection 300 includes a first step (i.e., collect valid pages 302) which is illustrated by block 238a and block 238b having some valid pages and some invalid pages. The valid pages are written to the free pages of a free block (e.g., block 244a). In the second step (i.e., erase blocks of invalid pages 304), the blocks with invalid pages (i.e., block 238a and block 238b) are erased. In the third step (i.e., reassign blocks 306), the controller marks the erased blocks as being free blocks (e.g., block 244a and block 244b) and the newly written block is marked as being used.

Wear leveling is another function that also results in write amplification. When data is repeatedly written in a certain area, the corresponding cells quickly wear out, so such repeated writing to the same cells should be prevented. Wear-leveling, a function that prevents repeated writing operations to a certain region, enables cells to be utilized evenly by swapping the blocks exposed to a high number of P/E cycles with free blocks, allowing the user to use the SSD longer under given conditions.

### Method for Dynamic Over-Provisioning

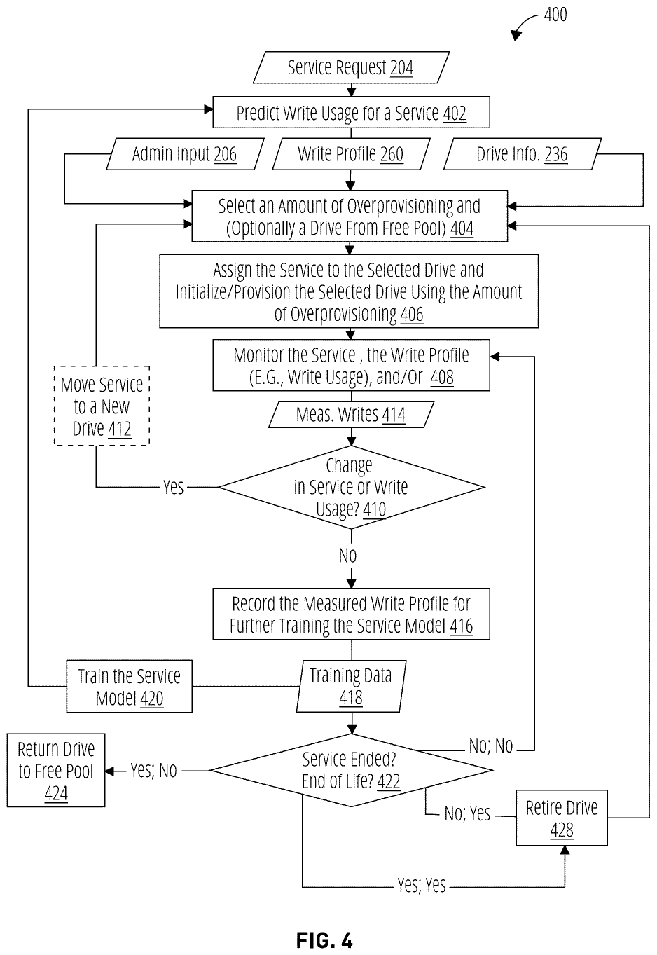

FIG. 4 illustrates an example method 400 for selecting and provisioning drives for respective services, including setting an amount of over-provisioning based, in part, on a write prolife (e.g., write usage) of a particular service. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

The systems and methods disclosed herein can optimize the amount of over-provisioning for a given service. The appropriate amount of over-provisioning can depend, among other things, on the degree to which write amplification is detrimental for the given service. Write amplification occurs when each host write (i.e., user data written from the host) results in additional drive controller-initiated writes (e.g., due to data management functions such as garbage collection and wear leveling). For example, write operations are carried out in pages while erase operations are executed in blocks. Thus, on SSDs, garbage collection creates free blocks by consolidating partial blocks, which have both valid and invalid pages, to free blocks and then erasing the partial blocks, which then become free blocks. Write amplification can be reduced by increasing the over-provisioning to increase the number of free blocks, resulting in a longer lifetime and improved performance (e.g., faster response). However, increasing the over-provisioning also decreases the available capacity of the SSD. For a given service/workload, an optimal amount of over-provisioning can be determined that balances the tradeoff between available storage capacity and reducing write amplification. Selecting the optimal amount of over-provisioning depends on accurately predicting the write usage for a given service, and write usage might be dynamic (i.e., vary with time). The systems and methods disclosed herein address these two needs by enabling dynamic adjustment of the amount of over-provisioning and by improving estimates of the write usage for respective services

Service request 204 can include a description of a new service that is to be performed using one or more drives from a data storage system or a description of an existing that requires additional drives from the data storage system. For example, Service request 204 can include service description introduced in FIG. 2D.

According to some examples, in step 402, the method includes predicting a write profile 260 for a service. For example, control processor 208 illustrated in FIG. 2A may predict write profile 260 for the service in service request 204. As discussed above, service request 204 can include service description 248.

According to some examples, in step 404, the method includes selecting an amount of overprovisioning. Additionally, step 404 can include selecting a drive from the free pool (e.g., free-pool drives 224). This selection can be based on admin input 206, drive attributes 236, and write profile 260, as discussed above in FIG. 2A through FIG. 2E. For example, selection logic 222 illustrated in FIG. 2A may select an amount of overprovisioning and optionally select a drive from the free pool.

According to certain non-limiting examples, determining the amount of over-provisioning can be based on a predicted write profile (e.g., write profile 260) and one or more specifications of the storage drive (e.g., drive attributes 236), which can include an endurance specification. Further, determining the amount of over-provisioning can include estimating the write-amplification amounts corresponding to respective over-provisioning amounts and selecting the amount of over-provisioning based on a comparison of the predicted write profile and the write-amplification amounts to the endurance specification.

According to certain non-limiting examples, determining the amount of over-provisioning includes selecting the amount of over-provisioning based at least partly on a scheduled replacement date for the storage drive. Additionally or alternatively, the amount of over-provisioning can be selected based at least partly on the tradeoff between write amplification and available storage space on the storage drive. Additionally or alternatively, the amount of over-provisioning can be selected based at least partly on the tradeoff between write performance and the available storage space on the storage drive. Additionally or alternatively, the amount of over-provisioning can be selected based at least partly on the tradeoff between the endurance of the storage drive and the available storage space on the storage drive.

According to certain non-limiting examples, the amount of over-provisioning is determined based on a specified endurance rating of the storage drive. In this case, decision block 410 can include monitoring whether the storage drive, when performing the service, deviates from the specified endurance rating, and step 404 can include dynamically adjusting the amount of overprovisioning when the storage drive deviates from the specified endurance rating. For example, when the storage drive is a solid-state drive, the specified endurance rating can correspond to a number of drive writes per day or a combination of total bytes written together with a specified lifetime of the solid-state drive. In this case, decision block 410 can include monitoring whether the storage drive deviates from the specified endurance rating and further include determining a first metric corresponding to an average number of NAND writes of the storage drive when performing the service over a period and comparing the first metric to a first parameter corresponding to an average number of NAND writes when operating using the specified endurance rating.

According to some examples, in step 406, the method includes assigning the service to the selected drive and initializing the selected drive using the amount of overprovisioning. For example, control processor 208 illustrated in FIG. 2A may assign the service to the selected drive and initialize the selected drive using the amount of overprovisioning.

According to some examples, in step 408, the method includes monitoring the service and/or the write usage. For example, control processor 208 illustrated in FIG. 2A may monitor the service and/or the write usage. This monitoring can be periodic based on a predefined schedule or can be triggered by an event (e.g., when one or more predefined criteria are satisfied).

According to certain non-limiting examples, method 400 can monitor whether a measured write profile (e.g., measured write profile 414) of the service deviates from the predicted write profile (e.g., write profile 260) by more than a predefined threshold. When the measured write profile deviates from the predicted write profile by more than a predefined threshold, method 400 determines an updated amount of over-provisioning using the measured write profile at step 404. Then, at step 406, method 400 initializes another storage drive to operate using the updated amount of over-provisioning and moves the service to the other storage drive that is initialized and causes the other storage drive to execute the service using the updated amount of overprovisioning.

According to certain non-limiting examples, method 400 can monitor whether the measured write profile deviates from the predicted write profile by more than a predefined threshold. When it does, another service can be assigned to the storage drive. The other service can have another predicted write profile that differs from the measured write profile. An updated amount of over-provisioning can be determined using the other predicted write profile and write specifications of the storage drive. Then, the storage drive can be reinitialized to operate using the updated amount of over-provisioning, and the other service can be performed on the storage drive using the updated amount of over-provisioning.

For example, the amount of over-provisioning for the service can be selected to match the specified write usage of the drive. When the measured write usage of the service exceeds the specified write usage, then the drive will have undergone more wear than was specified. Accordingly, the drive might be re-provisioned to perform another service (e.g., a less write-heavy service), such that over time, the total amount of wear on the drive will be more aligned with the intended lifetime for the drive.

According to certain non-limiting examples, a combination of the predicted write profile and the amount of over-provisioning provides a first write usage that corresponds to a specified write usage. The measured write profile indicates a second write usage. A combination of the other predicted write profile and the updated amount of over-provisioning provides a third write usage. When the second write usage is greater than the specified write usage, the other service is selected such that the third write usage is less than the specified write usage. When the second write usage is less than the specified write usage, the other service is selected such that the third write usage is greater than the specified write usage.

According to certain non-limiting examples, the other service is selected based on the other predicted write profile and the updated amount of over-provisioning providing a date of expiration for the storage drive that is closer to a replacement date for the storage drive than an expiration date generated based on the predicted write profile and the amount of over-provisioning.

According to some examples, in decision block 410, the method detects when there are significant changes in the service or write profile 260 (e.g., changes to the write usage). For example, control processor 208 illustrated in FIG. 2A may detect when changes in the service or write profile 260. If the changes are deemed significant, method 400 returns step 404. For example, step 412 can initiate moving the service to a new drive. Method 400 reports measured write profile 414 to step 404, and measured write profile 414 can be used instead of (or together with write profile 260) to select the amount of over-provisioning for the service being performed on the new drive.

According to certain non-limiting examples, the write profile includes a write usage, a percentage of host writes that are random writes, and another percentage of the host writes that are sequential writes. The predicted write profile includes predicting, based on a description of the service, the write usage, the percentage of host writes that are random writes, and the other percentage of the host writes that are sequential writes. The amount of over-provisioning can be determined based on predicting a write amplification for the amount of over-provisioning based on the write usage, the percentage of host writes that are random writes, and the other percentage of the host writes that are sequential writes.

According to certain non-limiting examples, determining the predicted write profile includes predicting a write usage based on a description of the service. In this case, determining the amount of over-provisioning can include setting the amount of over-provisioning to a minimum value when the write usage is less than a first threshold, and setting the amount of over-provisioning to a maximum value when the write usage exceeds a second threshold. When the write usage is between the first and second threshold, the amount of over-provisioning can be set to a value that monotonically increases from the minimum value to the maximum value as the write usage increases from first threshold to the second threshold.

According to some examples, in step 412, the method includes moving the service to a new drive. For example, control processor 208 illustrated in FIG. 2A may move the service to a new drive.

According to some examples, in step 416, the method includes recording the drive's measured write profile while performing the service and creating a historical record (e.g., training data 418) for training the service model.

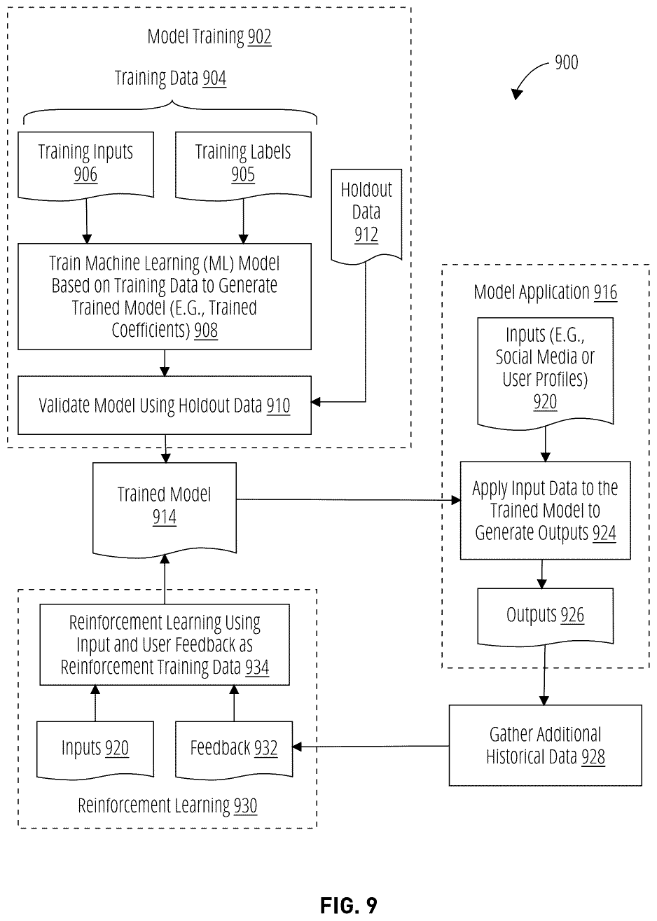

According to some examples, in step 420, the method includes training the service model using training data 418. For example, method 900 illustrated in FIG. 9 can be used to train the service model. For example, the model can initially be trained using historical data, and step 420 can be used for reinforcement learning to fine-tune and keep the service model 210 up to date.

According to certain non-limiting examples, service model 210 used in step 402 to predict write profile 260 can be a machine learning model, which can include one or more machine training models trained using historical data in which respective services are associated with corresponding write profiles, and each of the write profiles includes a frequency of host writes of an associated service. Service model 210 is then trained to predict a write profile for a given service based on descriptions of the given service.

According to some examples, in decision block 422, the method inquiries whether the service ended and whether the drive has reached its end of life.

For the case of “no” end to the service and “no” end of life for the drive (i.e., the “no; no” case), method 400 returns from decision block 422 to step 404.

For the case of “no” end to the service and “yes” to the end of life for the drive (i.e., the “no; yes” case), method 400 returns from decision block 422 to step 404 via step 428. That is, the current drive is retired, and, at step 404, method 400 selects a new drive to perform the service.

For the case of “yes” the service has ended and and “yes” to the end of life for the drive has been reached (i.e., the “yes; yes” case), method 400 retires the current drive at step 428 without continuing back to step 404, and method 400 is suspended until a new service request 204 is received.

For the case of “yes” the service has ended and and “no” the end of life for the drive has not been reached (i.e., the “yes; no” case), method 400 continues to step 424 at which the current drive is returned to the free pool of drives that have not been allocated to a particular service, and method 400 is suspended until a new service request 204 is received.

According to some examples, in step 424, after the service has ended, the drive is returned to the free pool (e.g., free-pool drives 224). For example, data storage system 220 illustrated in FIG. 2A may return the drive to free pool.

According to some examples, in step 428, after the life of the drive has reached its ended, the drive is retired to the free pool (e.g., removed from data storage system 220).

### Data Centers

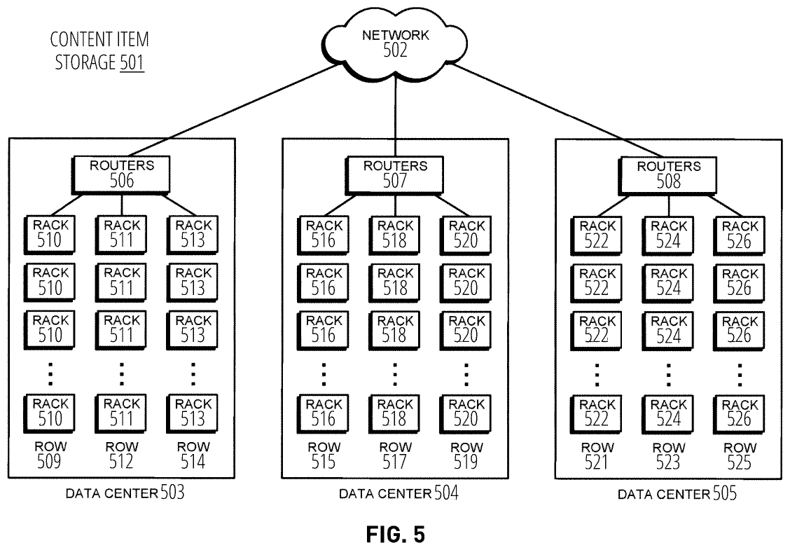

FIG. 5 illustrates a content item storage 501 that comprises a data centers 503, 504, and 505 in accordance with the disclosed embodiments. Although the example system depicts particular system components and an arrangement of such components, this depiction is to facilitate a discussion of the present technology and should not be considered limiting unless specified in the appended claims. For example, some components that are illustrated as separate can be combined with other components, some components can be divided into separate components, some components might not be present or needed, and additional components may be present.

Data centers provide the infrastructure for the content item storage 501. Note that content item storage 501 can be smaller than the system illustrated in FIG. 5. (For example, content item storage 501 can comprise a single server that is connected to a number of disk drives, a single rack that houses a number of servers, a row of racks, or a single data center with multiple rows of racks.) As illustrated in FIG. 5, content item storage 501 can include a set of geographically distributed data centers 503-505 that may be located in different states, different countries or even on different continents.

Data centers 503-505 are coupled together through a network 502, wherein network 502 can be a private network with dedicated communication links, or a public network, such as the Internet, or a virtual-private network (VPN) that operates over a public network.

Communications to each data center pass through a set of routers that route the communications to specific storage nodes within each data center. More specifically, communications with data center 503 pass through routers 506, communications with data center 504 pass through routers 507, and communications with data center 505 pass through routers 508.

As illustrated in FIG. 5, routers 506-508 channel communications to storage devices within the data centers, wherein the storage devices are incorporated into servers that are housed in racks, wherein the racks are organized into rows within each data center. For example, the racks within data center 503 are organized into row 509, 512 and 514, wherein row 509 includes racks 510, row 512 includes racks 511 and row 514 includes racks 513. The racks within data center 504 are organized into row 515, row 517 and row 519, wherein row 515 includes racks 516, row 517 includes racks 518 and row 519 includes racks 520. Finally, the racks within data center 505 are organized into row 521, row 523 and row 525, wherein row 521 includes racks 522, row 523 includes racks 524 and row 525 includes racks 526.

As illustrated in FIG. 5, content item storage 501 is organized hierarchically, comprising multiple data centers, wherein machines within each data center are organized into rows, wherein each row includes one or more racks, wherein each rack includes one or more servers, and wherein each server (also referred to as an “object storage device” (OSD)) includes one or more storage devices (e.g., disk drives).

### Data Storage System

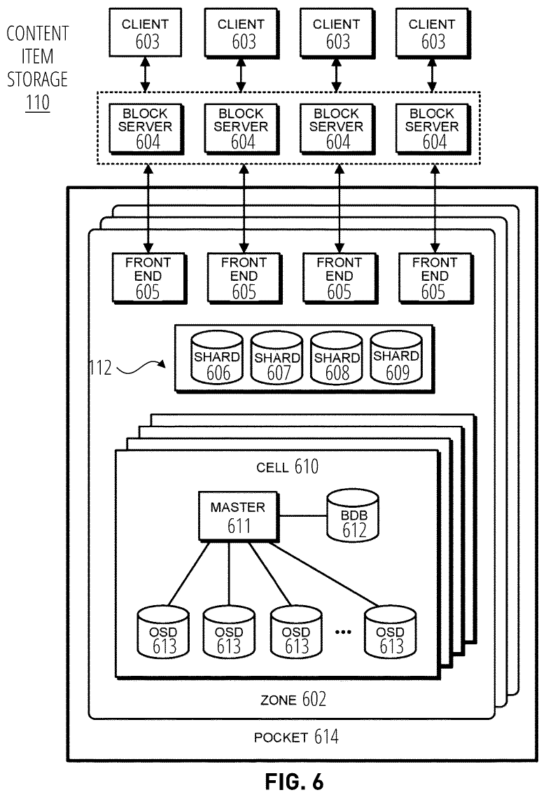

FIG. 6 illustrates the logical structure of the content item storage 110 in accordance with the disclosed embodiments. Although the example system depicts particular system components and an arrangement of such components, this depiction is to facilitate a discussion of the present technology and should not be considered limiting unless specified in the appended claims. For example, some components that are illustrated as separate can be combined with other components, some components can be divided into separate components, some components might not be present or needed, and additional components may be present.

As illustrated in FIG. 6, content item storage 110 includes a logical entity called a “pocket” 614 that, in some embodiments, is similar to an Amazon S3™ bucket. The pockets are distinct. For example, in a non-limiting implementation, the system provides a “block storage pocket” to store data files, and a “thumbnail pocket” to store thumbnail images for data objects. Applications, such as client application 116, specify which pockets are to be accessed.

Within a pocket one or more “zones” exist that are associated with physical data centers, and these physical data centers can reside at different geographic locations. For example, one data center might be located in California, another data center might be located in Virginia, and another data center might be located in Europe. For fault-tolerance purposes, data can be stored redundantly by maintaining multiple copies of the data on different servers within a single data center and also across multiple data centers.

For example, when a data item first enters a data center, it can be initially replicated to improve availability and provide fault tolerance. It can then be asynchronously propagated to other data centers.

Note that storing the data redundantly can simply involve making copies of data items, or alternatively using a more space-efficient encoding scheme, such as erasure codes (e.g., Reed-Solomon codes) or Hamming codes to provide fault tolerance.

Within zones (such as zone 602 in FIG. 6), there exists a set of storage front ends 605, a content item block database content item block database 112 and a set of “cells,” such as cell 610 illustrated in FIG. 6. A typical cell 610 includes a number of object storage devices 613, wherein object storage devices 613 include storage devices that actually store data blocks. Cell 610 also includes a storage master 611, which is in charge of managing object storage devices 613 and bucket database 612, described in more detail below. (Note that content item block database 112 and bucket database 612 are logical databases that can be stored redundantly in multiple physical databases to provide fault tolerance.)

Storage master 611 performs a number of actions. For example, storage master 611 can determine how many writeable buckets the system has at any point in time. If the system runs out of buckets, storage master 611 can create new buckets and allocate them to the storage devices. Storage master 611 can also monitor object storage devices 613 and associated storage devices, and if any object storage device 613 or other storage device fails, storage master 611 can migrate the associated buckets to other object storage devices. In some embodiments, storage master 611 is a service which coordinates all volume operations in a pocket 614 cell 610.

As illustrated in FIG. 6, a number of block servers 604, which are typically located in a data center associated with a zone, can service requests from a number of clients 603. For example, a client 603, such as client device 114, can comprise applications running on client machines and/or devices that access data items in content item storage 110. Block servers 604 in turn forward the requests to storage front end 605 that are located within specific zones, such as zone 602 illustrated in FIG. 6. Note clients 603 communicate with storage front end 605 through block servers 604, and storage front ends 605 are the only machines within the zones that have public IP addresses.

Content items to be stored in content item storage 110 comprise one or more data blocks that are individually stored in content item storage 110. For example, a large file can be associated with multiple data blocks, wherein each data block is 1 MB to 4 MBs in size.

Moreover, each data block is associated with a “hash” that serves as a global identifier for the data block. The hash can be computed from the data block by running the data block through a hash function, such as a SHA-256 hash function. (The SHA-256 hash function is defined as a Federal Information Processing Standard (FIPS) by the U.S. National Institute of Standards and Technology (NIST).) The hash is used by content item storage 110 to determine where the associated data block is stored.

A large number of data blocks can exist in content item storage 110. Thus, content item block database 112 can potentially be very large. If content item block database 112 is very large, it is advantageous to structure content item block database 112 as a “sharded” database. For example, when performing a lookup based on a hash in content item block database 112, the first 8 bits of the hash can be used to associate the hash with one of 260 possible shards, and this shard can be used to direct the lookup to an associated instance of content item block database 112. For example, as illustrated in FIG. 6, content item block database 112 can comprise 4 instance 606, 607, 608, and 609, wherein instance 606 is associated with shards 1-64, instance 607 is associated with shards 65-128, instance 608 is associated with shards 129-192 and instance 609 is associated with shards 193-260.

In some embodiments, content item block database 112 identifies where in Pocket 614 each block is located (e.g., mapping from the block's key to the cell 610 and Bucket ID, which is recording in bucket database 612.

Content item block database 112 instance 606-609 are logical databases that are mapped to physical databases, and to provide fault tolerance, each logical database can be redundantly stored in multiple physical databases. For example, in one embodiment, each content item block database 112 instance maps to three physical databases. If content item storage 110 is very large (for example containing trillions of data blocks), content item block database 112 will be too large to fit in random-access memory. In this case, content item block database 112 will mainly be stored in non-volatile storage, which can comprise flash drives or disk drives.

### Object Storage Device

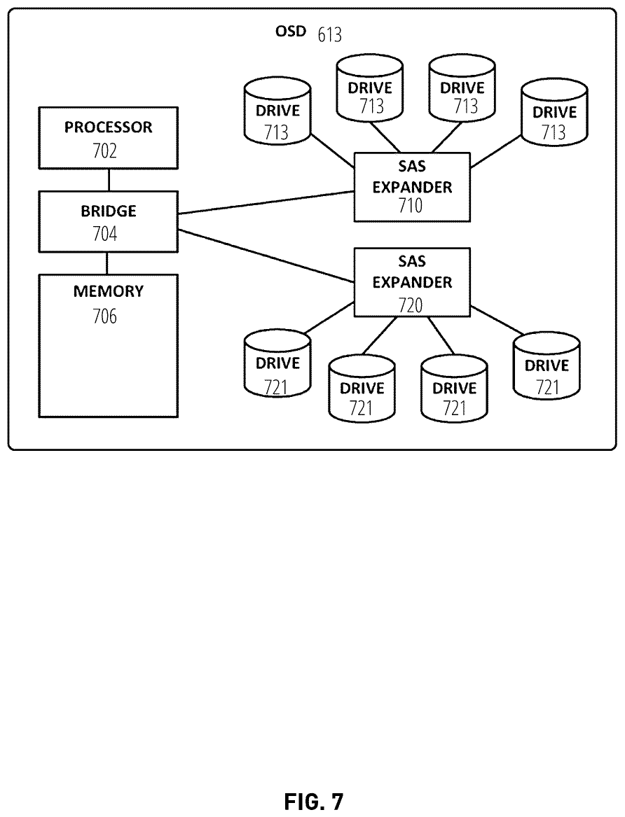

FIG. 7 illustrates the structure of an object storage device 613 in accordance with the disclosed embodiments. As illustrated in FIG. 7, object storage device 613 includes a processor 702 that is connected to a memory 706 through a bridge 704. Processor 702 is also coupled to Serial Attached SCSI (SAS) expander 710 and SAS expander 720, where SAS expander 710 is coupled to disk drives 713 and SAS expander 720 is coupled to disk drives 721. (Note that SAS expanders 710 and 720 may be coupled to more or fewer disk drives.) Also, note that a failure in object storage device 613 can involve a failure of a single disk drive of the disk drives 713 or disk drives 721, or a failure that affects all or most of object storage device 613, such as a failure in processor 702, bridge 704, memory 706, SAS expanders 710 and 720 or one of the associated data paths.

FIG. 8 shows a simple block diagram of a non-limiting example of a solid-state drive architecture 832. Data is received from host 806, which includes host bus adapter 808. According to certain non-limiting examples, host reads and writes 824 are routed through SAS expander 810 to solid-state drive architecture 832. Data transferred to and from the solid-state drive architecture 832 passes through a host interface 804, which can be configured for different interfaces (e.g., PATA, SATA, SCSI, SAS, etc.). Host interface 804 is connected to two buses, control bus 822, which is a system bus used for addressing and control, and a data bus 816 (indicated by the dash lines), providing the data path through DRAM buffer 818 and flash controller 820 to the NAND flash (e.g., flash 826a, flash 826b, flash 826c, and flash 826d). Connected to the control bus is processor 814 (e.g., a central processing unit (CPU) or a microcontroller), flash controller 820, and RAM 812 (e.g., a static random access memory (SRAM)). For example, RAM 812 can be used for tables and logical-block-to-physical-block address mapping. According to certain non-limiting examples, RAM 812 can be SRAM that is volatile memory, in which case, pertinent information, such as tables and logical to physical address mapping can be continually backed up to NAND flash. Processor 814 can be the main controller for solid-state drive architecture 832, providing coordination of writing and reading to and from the flash memory (e.g., flash 826a, flash 826b, flash 826c, and flash 826d). Processor 814 can also execute and monitor the wear-leveling algorithms used on the flash memory. Flash controller 820 performs the control of addressing, programming, erasing and reading of the flash memory. The flash memory is accessed via respective channels. For example, channel 828 is used to access flash 826a and flash 826b, whereas channel 830 is used to access flash 826c and flash 826d.

According to certain non-limiting examples, host interface 804 handles the communication with the host OS, and host interface 804 can emulate a hard disk drive (HDD) interface. SSD controller 802 can provide control logic for basic functions for converting logical block address (LBAs) to logical flash page address and further to physical page address. This functionality can be referred to as the Flash Translation Layer (FTL). SSD controller 802 can further provide additional advanced features, such as interleaving, garbage collection, bad block management, and wear leveling. The flash memory can be an array of nonvolatile flash packages that are combined together to provide the total storage size of solid-state drive architecture 832. The array can be organized appropriately to achieve the required performance through interleaving.

FIG. 9 illustrates an example of training a machine learning (ML) model to generate trained model 914 to which inputs 920 are applied to generate outputs 926. FIG. 9 also illustrates an example of using reinforcement learning 930 to improve trained model 914 based on feedback 932. Method 900 includes three parts: (1) model training 902; (2) model application 916; and (3) reinforcement learning 930.

For example, method 900 can be used to train service model 210 and/or drive model 212 based on historical data. Training data 904 used to train service model 210 includes service descriptions 248 as training inputs 906 and write profiles 260 as training labels 905. Training data 904 can be historical data that represents descriptions of the previous services performed at a datacenter and these can be paired/associated with the historical write profiles of the respective services.

For drive model 212, training data 904 used to train the model can include service drive attributes 236 as training inputs 906 and write profiles predicted performance 278 as training labels 905.

In model training 902, training data 904 is applied to train the ML model. For example, the ML model can include one or more artificial neural networks (ANNs) that are trained via supervised or unsupervised learning using a backpropagation technique to train the weighting parameters between nodes within respective layers of the ANNs. Alternatively or additionally, the ML model can include other models, such as a random forest model, a linear regression model, a boosted trees model, a non-linear regression model, and/or a support vector machine, for example. Without loss of generality, method 900 is illustrated using the non-limiting example of the ML model being an ANN.

In supervised learning, the training data 904 is labeled such that the training data 904 includes training inputs 906 associated with training labels 905. The inputs in the training data 904 are applied to the ML model, and an error/loss function is generated by comparing the output from the ML model with the desired outputs/labels of the training data 904. Starting with the training inputs 906, the coefficients of the ML model are iteratively updated to reduce an error/loss function. The value of the error/loss function decreases as outputs from the ML model increasingly approximate the desired output. In other words, ANN infers the mapping implied by the training data, and the error/loss function produces an error value related to the mismatch between the desired output and the outputs from the ML model that are produced as a result of applying the training data 904 to the ML model.

Alternatively, for unsupervised learning or semi-supervised learning, training data 904 is applied to train the ML model. For example, the ML model can be an artificial neural network (ANN) that is trained via unsupervised or self-supervised learning using a backpropagation technique to train the weighting parameters between nodes within respective layers of the ANN.

In unsupervised learning, the training data 904 is applied as an input to the ML model, and an error/loss function is generated by comparing the predictions to other data in the training data 904 For example, in time series or prose (ordered words), the ML model can predict the next value in the series based on the previous values, and the error function is generated by comparing the predicted next value in a series to the actual next value in the series. The coefficients of the ML model can be iteratively updated to reduce an error/loss function. The value of the error/loss function decreases as outputs from the ML model increasingly approximate the training data 904.

Relatedly generative adversarial networks (GAN) can be trained using unlabeled training data and unsupervised learning by pitting two ML models (a generative ML model and a classifying ML model) against each other to train the ML models.

In certain implementations, the cost function can use the mean-squared error to minimize the average squared error. In the case of a of multilayer perceptrons (MLP) neural network, the backpropagation algorithm can be used for training the network by minimizing the mean-squared-error-based cost function using a gradient descent method.

Training a neural network model essentially means selecting one model from the set of allowed models (or, in a Bayesian framework, determining a distribution over the set of allowed models) that minimizes the cost criterion (i.e., the error value calculated using the error/loss function). Generally, the ANN can be trained using various algorithms for training neural network models (e.g., by applying optimization theory and statistical estimation).

For example, the optimization method used in training artificial neural networks can use some form of gradient descent, using backpropagation to compute the actual gradients. This is done by taking the derivative of the cost function with respect to the network parameters and then changing those parameters in a gradient-related direction. The backpropagation training algorithm can be: a steepest descent method (e.g., with variable learning rate, with variable learning rate and momentum, and resilient backpropagation), a quasi-Newton method (e.g., Broyden-Fletcher-Goldfarb-Shannon, one step secant, and Levenberg-Marquardt), or a conjugate gradient method (e.g., Fletcher-Reeves update, Polak-Ribidre update, Powell-Beale restart, and scaled conjugate gradient). Additionally, evolutionary methods, such as gene expression programming, simulated annealing, expectation-maximization, non-parametric methods and particle swarm optimization, can also be used for training the ML model.

In process 910, method 900 can also include various techniques to prevent overfitting to the training data 904 and for validating the trained process 924. For example, holdout data 912 can be used in process 910 to validate the trained ML model. The holdout data 912 can be a subset of the training data 904 that was not used in process 908, but was instead set aside to be used for validation. Additionally or alternatively, validation can be performed using bootstrapping and random sampling of the training data 904 can be used.

As understood by those of skill in the art, other methods can be used for the ML model including one or more of the following: hidden Markov models, recurrent neural networks (RNNs), convolutional neural networks (CNNs); Deep Learning networks, Bayesian symbolic methods, generative adversarial networks (GANs), support vector machines. As discussed above, the ML model can include a regression algorithms, such as, but not limited to, a Stochastic Gradient Descent Regressors, and/or Passive Aggressive Regressors, etc.

The ML models can also include one or more clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, the ML model can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

In process 924, inputs 920 can be applied to the trained ML model (e.g., an ANN with the trained model 914) to generated the outputs 926.

In process 928, feedback 932 is generated for outputs 926. For example, outputs 926 can be dictions (e.g., predicted write profiles) that are compared to actual/measured values (e.g., measured write profiles). When the outputs 926 agree with the actual values the result provides a positive instance to be used as reinforcement training data. When the outputs 926 disagree with the actual values the result provides a negative instance to be used as reinforcement training data. Feedback 932 together with inputs 920 can be used as reinforcement training data to improve and update trained model 914. process 934 is performed similarly to process 908, except the training data is augmented to include the reinforcement training data. For example, the contribution to the loss function due to the reinforcement training data can be weighted more than the original training data (e.g., training data 904).

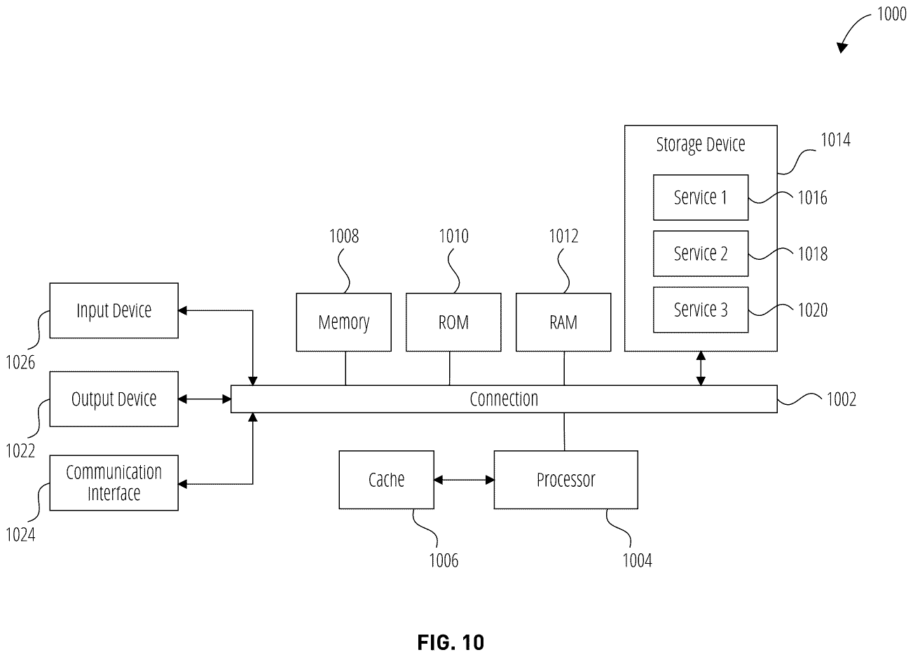

FIG. 10 shows an example of computing system 1000, which can be for example any computing device making up content item storage 110, or any component thereof in which the components of the system are in communication with each other using connection 1002. Further, computing system 1000 can be, e.g., any computing device making up system configuration 100, system 200, control processor 208, or solid-state drive architecture 832. Although the example system depicts particular system components and an arrangement of such components, this depiction is to facilitate a discussion of the present technology and should not be considered limiting unless specified in the appended claims. For example, some components that are illustrated as separate can be combined with other components, some components can be divided into separate components, some components might not be present or needed, and additional components may be present.

Connection 1002 can be a physical connection via a bus, or a direct connection into processor 1004, such as in a chipset architecture. Connection 1002 can also be a virtual connection, networked connection, or logical connection.

In some embodiments, computing system 1000 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 1000 includes at least one processing unit (CPU) such as processor 1004 and connection 1002 that couples various system components including system memory 1008, such as read-only memory (e.g., ROM 1010) and random access memory (e.g., RAM 1012) to processor 1004. Computing system 1000 can include a cache of high-speed memory 1006 connected directly with, in close proximity to, or integrated as part of processor 1004.

Processor 1004 can include any general purpose processor and a hardware service or software service, such as services 1016, 1018, and 1020 stored in storage device 1014, configured to control processor 1004 as well as a special-purpose processor where software instructions are incorporated into the actual processor design. Processor 1004 may essentially be a completely self-contained computing system, containing multiple cores or processors, a bus, memory controller, cache, etc. A multi-core processor may be symmetric or asymmetric.

To enable user interaction, computing system 1000 includes an input device 1026, which can represent any number of input mechanisms, such as a microphone for speech, a touch-sensitive screen for gesture or graphical input, keyboard, mouse, motion input, speech, etc. Computing system 1000 can also include output device 1022, which can be one or more of a number of output mechanisms known to those of skill in the art. In some instances, multimodal systems can enable a user to provide multiple types of input/output to communicate with computing system 1000. Computing system 1000 can include communication interface 1024, which can generally govern and manage the user input and system output. There is no restriction on operating on any particular hardware arrangement, and therefore the basic features here may easily be substituted for improved hardware or firmware arrangements as they are developed.

Storage device 1014 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 1014 can include software services, servers, services, etc., that when the code that defines such software is executed by the processor 1004, it causes the system to perform a function. In some embodiments, a hardware service that performs a particular function can include the software component stored in a computer-readable medium in connection with the necessary hardware components, such as processor 1004, connection 1002, output device 1022, etc., to carry out the function.

For clarity of explanation, in some instances, the present technology may be presented as including individual functional blocks including functional blocks comprising devices, device components, steps or methods in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, e.g., instructions and data that cause or otherwise configure a general-purpose computer, special-purpose computer, or special-purpose processing device to perform a certain function or group of functions. Portions of computer resources used can be accessible over a network. The executable computer instructions may be, e.g., binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

For clarity of explanation, in some instances the present technology may be presented as including individual functional blocks including functional blocks comprising devices, device components, steps or methods in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

### Aspects

Aspect 1. A method of over-provisioning a storage drive, the method comprising: receiving a request for a service that uses a storage drive to provide the service; determining, using a first model, a predicted write profile for the service, the first model being based on historical data; determining an amount of over-provisioning based on the predicted write profile; initializing the storage drive to operate using the amount of over-provisioning; and causing the storage drive to perform the service using the amount of over-provisioning.

Aspect 2. The method of aspect 1, the method further comprising: obtaining the historical data associating respective services with corresponding write profiles, wherein for each of the corresponding write profiles, a write profile includes a frequency of host writes of an associated service; and training the first model to predict write profiles for services based on descriptions of the services, wherein the first model is a machine learning model.

Aspect 3. The method of aspect 1 or aspect 2, wherein determining the amount of over-provisioning includes selecting the amount of over-provisioning based on: a scheduled replacement date for the storage drive, a first tradeoff between write amplification and available storage space on the storage drive, a second tradeoff between write performance and the available storage space on the storage drive, or a third tradeoff between endurance of the storage drive and the available storage space on the storage drive.

Aspect 4. The method of any of aspect 1 through aspect 3, wherein determining the amount of over-provisioning is based on the predicted write profile and one or more attributes of the storage drive.

Aspect 5. The method of aspect 4, wherein the one or more attributes of the storage drive include an endurance specification, and determining the amount of over-provisioning includes estimating write-amplification amounts corresponding to respective over-provisioning amounts and selecting the amount of over-provisioning using a comparison of the predicted write profile and the write-amplification amounts to the endurance specification.

Aspect 6. The method of aspect 4, wherein the one or more attributes of the storage drive including at least one of (1) bytes written to the storage drive, (2) percentage used of the storage drive, (3) power on hours of the storage drive, (4) a model of the storage drive, or (5) drive writes per day of the storage drive and determining the amount of over-provisioning includes analyzing the predicted write profile together with the one or more attributes of the storage drive.

Aspect 7. The method of any of aspect 1 through aspect 6, further comprising: monitoring whether a measured write profile of the service deviates from the predicted write profile by more than a predefined threshold; determining an updated amount of over-provisioning using the measured write profile; initializing another storage drive to operate using the updated amount of over-provisioning; moving the service to the other storage drive; and causing the other storage drive to execute the service using the updated amount of overprovisioning.

Aspect 8. The method of any of aspect 1 through aspect 7, wherein: the amount of over-provisioning is determined based on a specified endurance rating of the storage drive, and the method further comprises: monitoring whether the storage drive, when performing the service, deviates from the specified endurance rating; and dynamically adjusting the amount of overprovisioning when the storage drive deviates from the specified endurance rating.

Aspect 9. The method of any of aspect 1 through aspect 8, wherein: the storage drive is a solid-state drive, the specified endurance rating corresponds to a number of drive writes per day or a combination of a total bytes written together with a specified lifetime of the solid-state drive, and monitoring whether the storage drive deviates from the specified endurance rating include determining a first metric corresponding to an average number of NAND writes of the storage drive when performing the service over a period and comparing the first metric to a first parameter corresponding to an average number of NAND writes when operating using the specified endurance rating.

Aspect 10. The method of any of aspect 1 through aspect 9, further comprising: monitoring whether a measured write profile deviates from the predicted write profile by more than a predefined threshold; assigning another service to the storage drive, the other service having another predicted write profile that differs from the measured write profile; determining an updated amount of over-provisioning using the other predicted write profile and write specifications of the storage drive; reinitializing the storage drive to operate using the updated amount of over-provisioning; and performing the other service on the storage drive using the updated amount of over-provisioning.

Aspect 11. The method of aspect 10, wherein: a combination of the predicted write profile and the amount of over-provisioning provides a first write usage that corresponds to a specified write usage, the measured write profile indicates a second write usage, and a combination of the other predicted write profile and the updated amount of over-provisioning provides a third write usage, when the second write usage is greater than the specified write usage, the other service is selected such that the third write usage is less than the specified write usage, and when the second write usage is less than the specified write usage, the other service is selected such that the third write usage is greater than the specified write usage.

Aspect 12. The method of aspect 10, wherein the other service is selected based on the other predicted write profile and the updated amount of over-provisioning providing a date of expiration for the storage drive that is closer to a replacement date for the storage drive than an expiration date generated based on the predicted write profile and the amount of over-provisioning.

Aspect 13. The method of any of aspect 1 through aspect 12, wherein: the write profile includes a write usage, a percentage of host writes that are random writes, and another percentage of the host writes that are sequential writes, determining the predicted write profile includes predicting, based on a description of the service, the write usage, the percentage of host writes that are random writes, and the other percentage of the host writes that are sequential writes, and determining the amount of over-provisioning includes predicting a write amplification for the amount of over-provisioning based on the write usage, the percentage of host writes that are random writes, and the other percentage of the host writes that are sequential writes.

Aspect 14. The method of any of aspect 1 through aspect 13, wherein: determining the predicted write profile includes predicting, based on a description of the service, a write usage, and determining the amount of over-provisioning includes: setting the amount of over-provisioning to a minimum value when the write usage is less than a first threshold, setting the amount of over-provisioning to a maximum value when the write usage exceeds a second threshold, and otherwise setting the amount of over-provisioning to a value that monotonically increases from the minimum value to the maximum value as the write usage increases from first threshold to the second threshold.

Aspect 15. The method of any of aspect 1 through aspect 14, further comprising: determining that the service ended; receiving another request for another service that uses the storage drive to provide the other service; determining, using the first model, another predicted write profile for the other service based; determining an updated amount of over-provisioning based on the other predicted write profile; initializing the storage drive to operate using the updated amount of over-provisioning; and causing the storage drive to perform the other service using the updated amount of over-provisioning.

Aspect 16. The method of any of aspect 1 through aspect 15, further comprising: selecting the storage drive from a plurality of storage drives based on a comparison of the predicted write profile and a remaining life for each of plurality of storage drives.

Aspect 17. The method of any of aspect 1 through aspect 16, wherein determining the amount of over-provisioning is performed using a second model that is a machine learning model, the second model predicting write amplification in response to an input including an input write profile and an input over-provisioning amount, and the second model having been trained using historical data in which measured write amplifications are associated with corresponding write profiles and over-provisioning amounts.

Aspect 18. The method of any of aspect 1 through aspect 17, wherein the storage drive is a solid-state drive comprising NAND storage cells.

Aspect 19. The method of any of aspect 1 through aspect 18, the storage drive is a solid-state drive, and monitoring whether the storage drive deviates from the specified endurance rating includes determining a first metric corresponding to an average number of NAND writes of the storage drive when performing the first service over a period.

Aspect 20. The method of any of aspect 1 through aspect 19, further comprising: obtaining a measured write profile of the storage drive and one or more attributes of the storage drive; applying the measured write profile and the one or more attributes of the storage drive to an aging model that determines an end of life of the storage drive; and retiring the storage drive upon the storage drive reaching the end of life

Aspect 19. A computing apparatus comprising: a processor; and a memory storing instructions that, when executed by the processor, configure the apparatus to perform the method of any of aspect 1 through aspect 20.

Aspect 20. A non-transitory computer-readable storage medium, the computer-readable storage medium including instructions that when executed by a computer, cause the computer to perform the method of any of aspect 1 through aspect 20.

What is claimed is:

1. A method of over-provisioning a storage drive, the method comprising:
receiving a first request identifying a first service that requires a storage drive;
determining, using a model, a predicted write profile for the first service, the model having been trained on historical data;
determining an amount of over-provisioning based on the predicted write profile to provide a determined amount of over-provisioning;
initializing the storage drive to operate using the determined amount of over-provisioning; and
causing the storage drive to perform the first service using the determined amount of over-provisioning.

2. The method of claim 1, the method further comprising:
obtaining the historical data associating respective services with corresponding write profiles, wherein for each of the corresponding write profiles, a write profile includes a frequency of host writes of an associated service; and
training the model to predict write profiles for services based on descriptions of the services, wherein the model comprises one or more machine learning models.

3. The method of claim 1, wherein determining the amount of over-provisioning includes estimating write-amplification amounts corresponding to respective over-provisioning amounts and selecting the amount of over-provisioning using a comparison of the predicted write profile and the write-amplification amounts to an endurance specification of the storage drive.

4. The method of claim 1, further comprising:
measuring a write profile of the first service while the first service is performed on the storage drive to provide a measured write profile;
determining an updated amount of over-provisioning based on the measured write profile;
initializing another storage drive to operate using the updated amount of over-provisioning;
moving the first service to the other storage drive; and
causing the other storage drive to execute the first service using the updated amount of overprovisioning.

5. The method of claim 1, further comprising:
determining that the first service ended;
receiving a second request identifying a second service;
determining, using the model, another predicted write profile for the second service based;
determining an updated amount of over-provisioning based on the second predicted write profile;
initializing the storage drive to operate using the updated amount of over-provisioning; and
causing the storage drive to perform the second service using the updated amount of over-provisioning.

6. The method of claim 1, further comprising:
selecting the storage drive from a plurality of storage drives based on a comparison of the predicted write profile and a remaining life for each of plurality of storage drives.

7. The method of claim 1, further comprising:
obtaining a measured write profile of the storage drive and one or more attributes of the storage drive;
applying the measured write profile and the one or more attributes of the storage drive to an aging model that determines an end of life of the storage drive; and
retiring the storage drive upon the storage drive reaching the end of life.

8. A computing system comprising:
one or more processors; and
a memory storing instructions that, when executed by the one or more processors, cause the computing system to:
receive a first request identifying a service that requires a storage drive;
determine a predicted write profile for the service using a model that has been trained on historical data;
determine an amount of over-provisioning based on the predicted write profile to provide a determined amount of over-provisioning;
initialize the storage drive to operate using the determined amount of over-provisioning; and
cause the storage drive to perform the service using the determined amount of over-provisioning.

9. The computing system of claim 8, wherein:
the determined amount of over-provisioning is determined based on a specified endurance rating of the storage drive, and
the instructions further configure the one or more processors to:
monitor whether the storage drive, when performing the service, deviates from the specified endurance rating; and
dynamically adjust the amount of overprovisioning when the storage drive deviates from the specified endurance rating.

10. The computing system of claim 8, wherein the instructions further cause the computing system to:
determine the determined amount of over-provisioning is based on the predicted write profile and one or more attributes of the storage drive, and
the one or more attributes of the storage drive include an endurance specification.

11. The computing system of claim 8, wherein the instructions further cause the computing system to:
assign a second service to the storage drive, the second service having a second predicted write profile;
determining an updated amount of over-provisioning using the second predicted write profile and write specifications of the storage drive;
reinitialize the storage drive to operate using the updated amount of over-provisioning; and
perform the second service on the storage drive using the updated amount of over-provisioning.

12. The computing system of claim 11, wherein the second service is selected to compensate for the first service either having a greater or a smaller write usage than a write usage corresponding to the predicted write profile.

13. The computing system of claim 11, wherein the second service is selected based on the second predicted write profile, the updated amount of over-provisioning, and a specified endurance of the storage drive.

14. The computing system of claim 8, wherein the instructions further cause the computing system to:
monitor whether a measured write profile of the service deviates from the predicted write profile by more than a predefined threshold;
determine an updated amount of over-provisioning using the measured write profile;
initialize another storage drive to operate using the updated amount of over-provisioning;
move the service to the other storage drive; and
cause the other storage drive to execute the service using the updated amount of overprovisioning.

15. A non-transitory computer-readable storage medium, the computer-readable storage medium including instructions that when executed by a computing system, cause the computing system to:
receive a request identifying a first service that requires a storage drive;
determine, based on a write profile of the first service, an amount of over-provisioning for the storage drive when performing the first service;
cause the storage drive to perform the service using the amount of over-provisioning;
monitor whether the storage drive, when performing the first service, deviates from the write profile that was used to determine the amount of over-provisioning; and
adjust the determined amount of overprovisioning when the storage drive deviates from the write profile.

16. The non-transitory computer-readable storage medium of claim 15, wherein the instructions cause the computing system to:
predict the write profile for the first service using a model that is based on historical data, and
determine the amount of over-provisioning based on a specified endurance rating of the storage drive and the write profile.

17. The non-transitory computer-readable storage medium of claim 15, wherein the instructions cause the computing system to:
determine the write profile of the first service using a model that has been trained on historical data, wherein
the historical data associates respective services with corresponding write profiles, wherein for each of the corresponding write profiles, a write profile includes a frequency of host writes of an associated service, and
the model comprises one or more machine learning models that have been trained to predict write profiles for services based on descriptions of the services.

18. The non-transitory computer-readable storage medium of claim 15, wherein:
the write profile includes a write usage and a write distribution value representing a ratio of random writes to host writes, a ratio of sequential writes to the host writes, a ratio of the sequential writes to the random writes, or a combination thereof, and
the instructions further cause the computing system to:
determine the write profile based on a description of the first service, the write usage and the write distribution value, and
determine the amount of over-provisioning based on a predicted write amplification corresponding the amount of over-provisioning, the write usage, and the write distribution value.

19. The non-transitory computer-readable storage medium of claim 15, wherein the instructions cause the computing system to:
determine the write profile based on a description of the first service, a write usage, and
determine the amount of over-provisioning based on a comparison of the write usage to at least one of a minimum threshold or a maximum threshold.

20. The non-transitory computer-readable storage medium of claim 15, wherein the instructions cause the computing system to:
determine the amount of over-provisioning based on at least one of:
a scheduled replacement date for the storage drive,
a first tradeoff between write amplification and available storage space on the storage drive,
a second tradeoff between write performance and the available storage space on the storage drive, or
a third tradeoff between endurance of the storage drive and the available storage space on the storage drive.
